(19) United States
(12) Patent Application Publication
(10) Pub. No.: US 2011/0299868 A1
(43) Pub. Date: Dec. 8, 2011

(54) FIXING APPARATUS

(75) Inventor: Mitsuhiro ITO, Numazu-shi (JP)

(73) Assignee: CANON KABUSHIKI KAISHA, Tokyo (JP)

(21) Appl. No.: 13/117,354

(22) Filed: May 27, 2011

(30) Foreign Application Priority Data
Jun. 3, 2010 (JP) 2010-127973

(51) Int. Cl. G03G 15/20; G03G 15/00

(52) U.S. Cl. 399/69; 399/88

(57) ABSTRACT

An object is to perform control so that power supplied in positive half-waves and power supplied in negative half-waves are symmetric in a control period even if a safety circuit based on a hardware circuit is activated. A CPU 202a controls to supply power of six half-waves from a third half-wave to an eighth half-wave (sections of E to K of a power supply waveform) after a limitation in the supply of the power by the safety circuit is released if the safety circuit limits the supply of the power from an AC power supply 401 to a heater 301 in a third half-wave (section of C to D in the power supply waveform) in the control period.

### BACKGROUND OF THE INVENTION

1. Field of the Invention

The present invention relates to a fixing apparatus that fixes a toner image on recording sheet, and particularly, to a heater control method of a fixing apparatus.

2. Description of the Related Art

Conventionally, a heat roller-type heat fixing apparatus or a film heating-type heat fixing apparatus is used as a fixing apparatus that heats and fixes a toner image formed on a recording sheet in an image forming apparatus, such as a copy machine and a laser beam printer. A halogen heater is the heat source of the heat roller-type heat fixing apparatus, and a ceramic heater is the heat source of the film heating-type heat fixing apparatus. In general, the heater is connected to an AC power supply through a switching element such as a bidirectional thyristor (hereinafter, called “triac”), and the AC power supply supplies power to the heater. The fixing apparatus includes a temperature detection element such as a thermistor thermosensing element. The CPU controls on/off of the switching element based on temperature information of the fixing apparatus detected by the temperature detection element to turn on/off the power supply to the heater to control the temperature of the fixing apparatus to a target temperature. The on/off control of the power supply to the heater is performed by phase control or wave number control. The phase control is a system of supplying power to the heater by turning on the heater at an arbitrary phase angle within a half-wave of the AC power supply. The wave number control is a power control system for turning on/off the heater on the basis of half-waves of the AC power supply. A system with a combination of the phase control and the wave number control (hereinafter, called “phase/wave number combination control”) is also used without fixing the control of the heater to one of the controls. For example, in Japanese Patent Application Laid-Open No. 2003-123941, the phase control is applied to some half-waves in a control period with a plurality of half-waves, and the wave number control is applied to the rest. As a result, generation of a harmonic current or switching noise can be prevented compared to when only the phase control is applied. A flicker can be reduced compared to when only the wave number control is applied, and the power to the heater can be controlled in more stages.

The fixing apparatus does not normally operate if one of the heater, the power supply, the temperature detection element, and the power control unit does not normally function. For example, when firmware of a control board serves as the power control unit to control the power and if an uncontrollable conduction of the heater occurs due to a firmware overrun, the fixing apparatus may be overheated and damaged. Therefore, a safety circuit made up of a hardware circuit is included in the fixing apparatus to prevent the overheating during the firmware overrun. For example, Japanese Patent Application Laid-Open No. 2008-275900 proposes a safety circuit that limits the charge power to the heater by a hardware circuit according to conditions of rotation of a pressuring roller as a rotating body arranged opposite the heater.

As the power supplied to the heater is continuously increasing due to the increase in the printing speed of recent years, the current value of the fixing apparatus also tends to increase, and the control is performed at a value close to a standard upper limit in some cases although not exceeding the standard upper limit. The transfer speed is increasing along with the increase in the speed of the image forming apparatus, and a higher heating temperature of the fixing apparatus or more accuracy in the heating temperature is demanded. Therefore, more detailed power control is necessary, and the phase/wave number combination control is often adopted. There is a request of “prohibition of asymmetric control” of section 6.1 of immunity standards IEC 61000-3-2 for harmonic wave control. To satisfy the standard, a conduction pattern needs to be set to make the amount of energy of positive half-waves and the amount of energy of negative half-waves the same in a control period.

The following problem occurs when a safety circuit based on a hardware circuit is mounted on an apparatus that performs the wave number control or the phase/wave number combination control and that controls the power based on a conduction pattern that does not lead to the asymmetric control in a control period. That is, if some waveforms in a control period are not conducted when the safety circuit based on the hardware circuit is activated within a period of the control period including the conduction pattern that does not lead to the asymmetric control, the conduction pattern of the symmetric control is destroyed. Therefore, there is a problem that the asymmetric control remains even after the release of the safety circuit.

### SUMMARY OF THE INVENTION

The present invention provides a fixing apparatus that controls to make power supplied in positive half-waves and power supplied in negative half-waves symmetric in a control period even if a safety circuit based on a hardware circuit is operated.

To solve the problem, the present invention has the following configuration.

A fixing apparatus including: a heating unit including a heating element that heats a toner image; a control unit that controls power supplied from an AC power supply to the heating element; and a limiting unit that limits the supply of power from the AC power supply to the heating element by a hardware circuit, wherein the control unit controls to make the power supplied in positive half-waves and the power supplied in negative half-waves symmetric in a control period including a plurality of N half-waves (N: integer) of the AC power supply, and the control unit controls to supply the power of (N-M+1) half-waves (M: integer) from an M-th half-wave to an N-th half-wave after a limitation of the supply of the power by the limiting unit is released if the limiting unit limits the supply of the power from the AC power supply to the heating element at the M-th half-wave in the control period.

Further features of the present invention will become apparent from the following description of exemplary embodiments with reference to the attached drawings.

### BRIEF DESCRIPTION OF THE DRAWINGS

FIG. 1A is a schematic diagram of a printer including a fixing device of first to fifth embodiments.

FIG. 1B is a block diagram of the printer including the fixing device of the first to fifth embodiments.

FIG. 2A is a schematic cross-sectional view of the fixing device of the first, second, and fourth embodiments.

FIG. 2B is an enlarged schematic cross-sectional view of a heater of the first, second, and fourth embodiments.

FIG. 2C is a schematic plan view of the heater of the first, second, and fourth embodiments.

FIG. 3 is a circuit configuration diagram of the fixing device of the first and fourth embodiments.

FIG. 4 is a control explanatory view of a heater power control system of the first to fifth embodiments.

FIG. 5 is an operation explanatory view of a safety circuit of the first embodiment.

FIG. 6 is an explanatory view of heater conduction control of the first embodiment.

FIG. 7 is a flow chart illustrating heater conduction control in a control period of the first to third embodiments.

FIG. 8 is a circuit configuration diagram of the fixing device of the second embodiment.

FIG. 9 is an explanatory view of an operation of the safety circuit and the heater conduction control of the second embodiment.

FIG. 10A is a schematic cross-sectional view of the fixing device of the third and fifth embodiments.

FIG. 10B is an enlarged schematic cross-sectional view of the heater of the third and fifth embodiments.

FIG. 10C is a schematic plan view of the heater of the third and fifth embodiments.

FIG. 11 is a circuit configuration diagram of the fixing device of the third and fifth embodiments.

FIG. 12 is an operation explanatory view of the safety circuit of the third embodiment.

FIG. 13 is an explanatory view of the heater conduction control of the third embodiment.

FIG. 14 is an explanatory view of the operation of the safety circuit and the heater conduction control of the fourth embodiment.

FIG. 15 is a flow chart illustrating the heater conduction control in the control period of the fourth embodiment.

FIG. 16 is an operation explanatory view of the safety circuit of the fifth embodiment.

FIG. 17 is an explanatory view of the heater conduction control of the fifth embodiment.

FIG. 18 is a flow chart illustrating the heater conduction control in the control period of the fifth embodiment.

### DESCRIPTION OF THE EMBODIMENTS

Hereinafter, embodiments of the present invention will now be described in detail in accordance with the accompanying drawings.

### First Embodiment

[Configuration of Image Forming Apparatus]

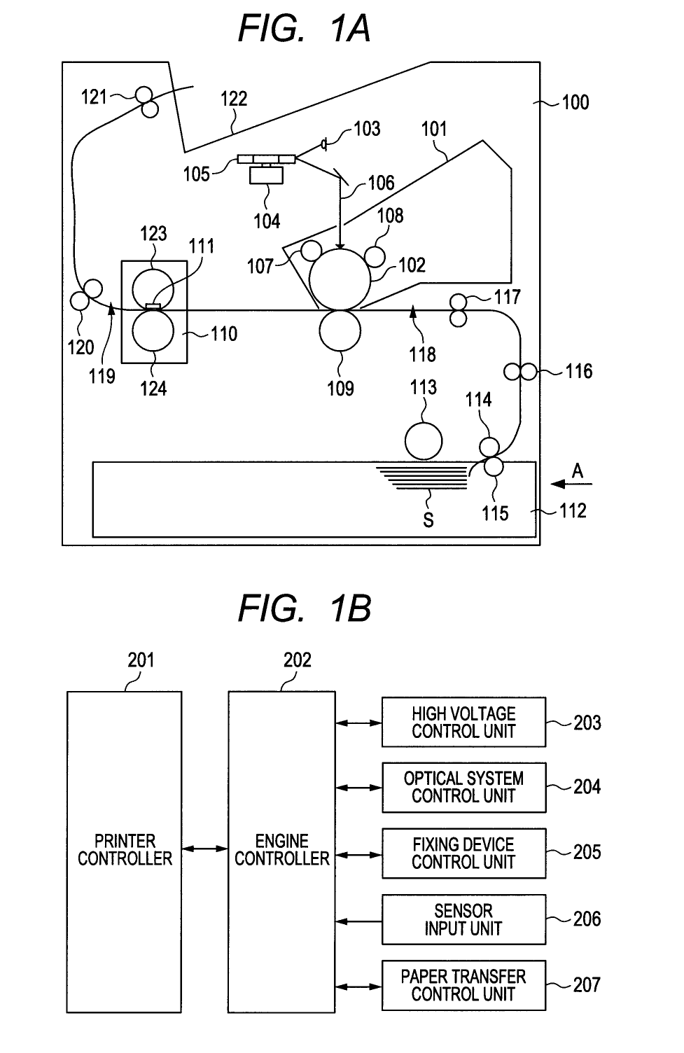

FIG. 1A is a schematic diagram illustrating a configuration of a printer (image forming apparatus) including a fixing device (fixing apparatus) of a first embodiment. A printer 100 includes a toner cartridge 101 removable from the printer 100. The printer 100 also includes a photosensitive drum 102 as an electrostatic carrier, a semiconductor laser 103 as a light source for emitting a laser beam 106 for scanning over the photosensitive drum 102, and a rotating polygon mirror 105 rotated by a scanner motor 104. A charging roller 107 uniformly charges over the photosensitive drum 102. A developing device 108 develops an electrostatic latent image formed on the photosensitive drum 102 by a toner. A transfer roller 109 transfers a toner image developed by the developing device 108 to predetermined recording sheet (hereinafter, simply called “sheet”) S. A fixing heater 111 of a fixing device 110 as a fixing apparatus fuses the toner transferred to the sheet S by heat. A fixing film 123 and a pressuring roller 124 heats, pressurizes, and fixes the toner on the sheet S (on the recording material) to the sheet S while transferring the sheet S. A sheet feeding cassette 112 stores the sheet S and is mounted on the printer 100 from the direction of an arrow A. A sheet feeding roller 113 rotates once to feed the sheet S from the sheet feeding cassette 112 and sends out the sheet S to a transfer path. A feed roller 114 and a retard roller 115 are a pair of rollers for separating one of the sheets S to send out the sheet S to the transfer path when the sheets S picked up by the sheet feeding roller 113 are a bundle of sheets. A pair of feed and retard rollers 116 transfer the sheet S fed from the sheet feeding cassette 112 to an image forming unit. A pre-transfer roller 117 sends the transferred sheet S to the photosensitive drum 102. A top sensor 118 synchronizes image writing (recording/printing) to the photosensitive drum 102 and the sheet transfer in relation to the fed sheet S and measures the length of the fed sheet S in the transfer direction. A fixing sensor 119 detects the presence of the sheet S after the fixing. A transfer roller 120 discharges the sheet S after the fixing to a sheet discharging transfer path. A sheet discharging roller 121 discharges the sheet S to a sheet discharging tray 122 that stacks the discharged sheet.

[Circuit Configuration]

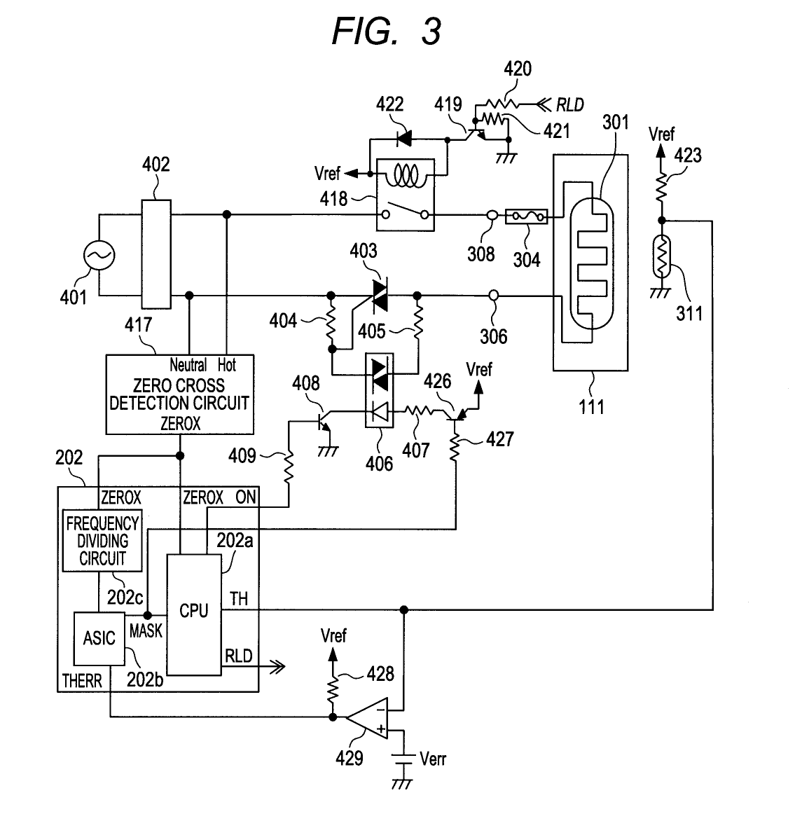

FIG. 1B is a block diagram of a circuit configuration of the present embodiment. A printer controller 201 expands image code data transmitted from an external device, such as a host computer (not illustrated), into bit data necessary for printing by the printer and reads and displays inside-information of the printer. An engine controller 202 controls print operations of components of the printer 100 according to an instruction of the printer controller 201 and notifies the printer controller 201 of the inside-information of the printer. The engine controller 202 includes a CPU 202a and an ASIC circuit 202b (see FIG. 3), and firmware is mounted on the CPU 202a. A high voltage control unit 203 controls each high voltage output in each process of charging, developing, transferring, and so on according to an instruction of the engine controller 202. An optical system control unit 204 controls the drive/termination of the scanner motor 104 and the emission of the laser beam 106 according to an instruction of the engine controller 202. A fixing device control unit 205 drives/terminates the conduction to the fixing heater 111 according to an instruction of the engine controller 202. A sensor input unit 206 notifies the engine controller 202 of sheet presence states of the top sensor 118, the fixing sensor 119, and a sheet position sensor (not illustrated) as well as a temperature state detected by a temperature detection element described later. A sheet transfer control unit 207 drives/terminates the motor/roller to transfer the sheet according to an instruction of the engine controller 202. The sheet transfer control unit 207 also controls the drive/termination of the sheet feeding roller 113, the pair of feed and retard rollers 116, the pre-transfer roller 117, the photosensitive drum 102, the fixing film 123, the pressuring roller 124, the transfer roller 120, and the sheet discharging roller 121.

[Configurations of Fixing Device and Heater]

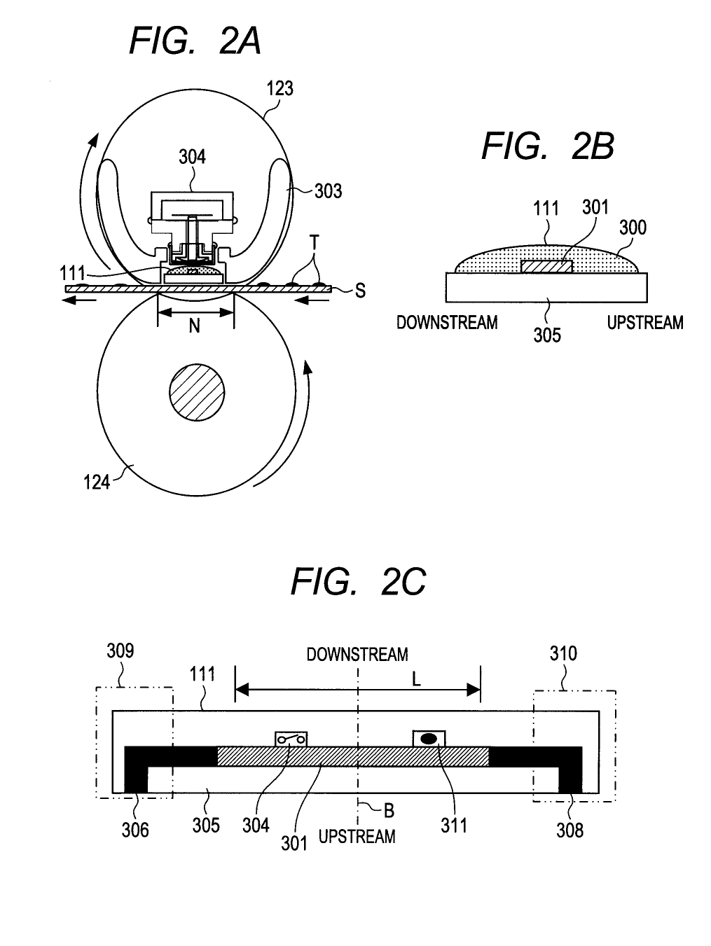

FIG. 2A is a schematic cross-sectional view of the fixing device 110 of the present embodiment. The fixing device 110 is, for example, a heating apparatus of a film heating system of a pressure roller drive type using an endless film (cylindrical film) described in Japanese Patent Application Laid-Open No. H04-044075. The fixing device 110 includes the fixing heater 111 as a heating unit and a heater holder 303, on which the fixing heater 111 is fixed and held, having a semicircular gutter-shape, heat-proofness, and rigidity. The fixing device 110 also includes a cylindrical thin heat-proof film (hereinafter, “fixing film”) 123 loosely fit onto the heater holder 303 to which the fixing heater 111 is attached. The fixing device 110 further includes a pressuring roller 124 as a rotatable pressuring member that sandwiches the fixing film 123 to mutually pressure contacts with the fixing film 123 with the fixing heater 111 to form a fixing nip portion N. A motor not illustrated as a drive unit rotates and drives the pressuring roller 124 at a predetermined peripheral velocity counterclockwise indicated by an arrow. A rotary force acts on the cylindrical fixing film 123 by frictional force of the pressure contacting at the fixing nip portion N of the outer surface of the pressuring roller 124 and the fixing film 123 based on the rotation of the pressuring roller 124. The fixing film 123 enters a driven rotation state clockwise indicated by an arrow around the heater holder 303 while the inner surface of the fixing film 123 slides by contacting with the downward surface of the fixing heater 111. Sliding grease may be applied to the interface between the fixing film 123 and the fixing heater 111. The fixing heater 111 is a ceramic heater (ceramic surface emission heater). The fixing heater 111 will be described later. The pressuring roller 124 is rotated and driven, and accordingly, the cylindrical fixing film 123 enters the driven rotation state. The fixing heater 111 is conducted, and the rising temperature is controlled at a predetermined temperature after the rise in the temperature of the fixing heater 111. In this state, the sheet S carrying a non-fixed toner image T is introduced between the fixing film 123 and the pressuring roller 124 at the fixing nip portion N. The toner image carrying side of the sheet S adheres to the outer surface of the fixing film 123 at the fixing nip portion N, and the sheet S is sandwiched and transferred through the fixing nip portion N along with the fixing film 123. The heat of the fixing heater 111 is provided to the sheet S through the fixing film 123 in the sandwich transfer process, and the non-fixed toner image T on the sheet S is heated, pressurized, fused, and fixed on the sheet S. The sheet S passing through the fixing nip portion N is self-stripped from the fixing film 123.

FIG. 2B is an enlarged schematic cross-sectional view of the fixing heater 111, and FIG. 2C is a plan schematic view of the fixing heater 111. The fixing heater 111 is a backside heating-type ceramic surface emission heater. An insulating substrate 305 is an electrical-insulating, excellent-thermal-conductivity, low-thermal-capacity, ceramic insulating substrate. A conduction heating element (heating element) (hereinafter, described “heater”) 301 formed on the backside of the insulating substrate 305 is connected by a conduction member from power feeding electrode portions (hereinafter, described “electrode portions”) 306 and 308 for the heater 301. A protection layer 300 is a protection layer of glass or the like formed by covering the heater 301 and the conduction member. In FIG. 2C, B denotes a center transfer reference line of the sheet S, and L denotes a sheet feeding width area of the maximum sized sheet that can be fed. The width denotes a length of the sheet S in the direction perpendicular to the transfer direction of the sheet S. A connector 309 of connectors 309 and 310 as power feeding connectors is installed on an electrode portion 306 side of the fixing heater 111 to electrically connect the electrode portion 306 and a drive control circuit side of the heater (also called “heater drive circuit”). The connector 310 is installed an electrode portion 308 side of the fixing heater 111 to electrically connect the electrode portion 308 and the heater drive circuit side. At a center section of the protection layer 300, a temperature detection element 311 that detects the center temperature of the fixing heater 111 and an excessive temperature rise prevention element 304 as an excessive temperature rise prevention unit, such as a fuse and a thermostat, are arranged at horizontally symmetric positions relative to the center transfer reference line B of the sheet S. The side of the fixing heater 111 opposite the side on which the heater 301 of the insulating substrate 305 is set as the surface side (fixing film sliding surface side), and the surface side faces downward as illustrated in FIG. 2A to be exposed outside. The fixing heater 111 is arranged by fixing and supporting at the lower surface of the heater holder 303. As illustrated in FIG. 2A, the excessive temperature rise prevention element 304 is abutted to the surface of the protection layer 300 of the fixing heater 111, and the position is corrected by the heater holder 303. A heat sensing surface of the excessive temperature rise prevention element 304 is abutted to the surface of the fixing heater 111 by a spring. Although not illustrated, the temperature detection element 311 is also similarly abutted to the surface of the protection layer 300 of the fixing heater 111. As illustrated in FIGS. 2B and 2C, the sheet S is transferred from the upstream to the downstream through the fixing nip portion N.

[Drive Control Circuit of Fixing Heater 111]

FIG. 3 is a drive control circuit diagram of the fixing heater 111. The heater 301 is heated by supplying power from an AC power supply 401 of the printer 100 to the heater 301 of the fixing heater 111 of the fixing device 110 through an AC filter 402 and a relay 418. The supply of power to the heater 301 is controlled by conduction and cutoff of a triac 403. Resistances 404 and 405 are bias resistances for the triac 403, and a phototriac coupler 406 is a device that secures a creepage distance between the primary and the secondary. The triac 403 is turned on by conducting a light emitting diode of the phototriac coupler 406. A resistance 407 is a resistance for limiting the current of the phototriac coupler 406, and a transistor 408 turns on/off the phototriac coupler 406. The transistor 408 operates according to an ON signal from the engine controller 202 through a resistance 409. The AC power supply 401 is input to a zero cross detection circuit 417 through the AC filter 402. The zero cross detection circuit 417 sends out a pulse signal (hereinafter, called “ZEROX signal”) to the engine controller 202, the signal indicating that a commercial power supply voltage is below a threshold. The engine controller 202 detects an edge of the pulse of the ZEROX signal and turns on/off the triac 403 based on the phase control or the wave number control.

The temperature detection element 311 (for example, a thermistor thermosensing element) that detects the temperature of the fixing heater 111 is arranged on the fixing heater 111 through the protection layer 300 with an insulation withstanding voltage so that an insulation distance can be secured relative to the heater 301. The temperature detected by the temperature detection element 311 is detected as partial pressures of a resistance 423 and the temperature detection element 311, and the temperature is A/D-input to the engine controller 202 as a TH signal. The engine controller 202 monitors the temperature of the fixing heater 111 as the TH signal. The CPU 202a of the engine controller 202 compares the temperature of the fixing heater 111 detected by the temperature detection element 311 and a set temperature of the fixing heater 111 set inside the engine controller 202 to calculate the power to be supplied to the heater 301. A phase angle (phase control) or a wave number (wave number control) corresponding to the calculated power to be supplied is converted, and the engine controller 202 sends out an ON signal to the transistor 408 based on the control condition.

If the temperature detection element 311 or the triac 403 is broken down, and the engine controller 202 determines that the temperature detection or the heater drive circuit is broken down, an RLD signal is turned off to turn off the relay 418, and the conduction to the heater 301 is cut off. A transistor 419 turns on/off the relay 418. The transistor 419 operates according to the RLD signal from the engine controller 202 through a resistance 420. A resistance 421 is a resistance for protecting the transistor 419. A diode 422 is an element that absorbs a back electromotive voltage generated when the relay 418 is off. Usually, the relay 418 is controlled to an on state by the RLD signal before the start of the power control to the heater 301 by the ON signal from the engine controller 202 and is controlled to an off state by the RLD signal after the end of the control of the power supply to the heater 301.

The excessive temperature rise prevention element 304, which is, for example, a temperature fuse or a thermo switch, supplies power to the heater 301 and plays a role as a last resort that prevents the excessive temperature rise when the unit for controlling is broken down and the heater 301 is out of control. If the heater 301 is out of control and the temperature of the excessive temperature rise prevention element 304 becomes greater than a predetermined temperature as a result of the failure of the unit that controls the power supply, the excessive temperature rise prevention element 304 opens, and the conduction to the heater 301 is cut off. The terminal of the hot side of the AC power supply 401 is connected to the excessive temperature rise prevention element 304 through the electrode portion 308. The electrode portion 306 is connected to the triac 403 that controls the heater 301 and connected to a neutral terminal of the AC power supply 401.

[Safety Circuit]

A safety circuit based on a hardware circuit will be described. The excessive temperature rise prevention element 304, which is one of the safety circuits based on hardware circuits, is the last resort. Once activated, the excessive temperature rise prevention element 304 cannot normally operate afterwards. Therefore, a safety circuit is separately installed to be activated before the last resort. For example, for the operation of the thermo switch of the excessive temperature rise prevention element 304 as the last resort at 250° C., a safety circuit that limits the conduction to 50% when the temperature reaches 200° C. is provided to prevent the rise of the temperature to 250° C. The safety circuit serves as a unit that detects the rise of the temperature to the temperature threshold 200° C. to input the voltage from the temperature detection element 311 to an inverting input of a comparator 429, input a reference voltage Verr equivalent to 200° C. to a non-inverting input, and output a comparison result as a THERR signal. A resistance 428 is a current limitation resistance. When the temperature detection element 311 is an NTC (Negative Temperature Coefficient) thermistor, the THERR signal is a high level if the temperature is higher than 200° C. The THERR signal is a low level if the temperature is lower than 200° C. The THERR signal is input to the ASIC circuit 202b of the engine controller 202.

A signal obtained by a frequency dividing circuit 202c dividing the frequency of the ZEROX signal into two is also input to the ASIC circuit 202b. The ASIC circuit 202b always sets a MASK signal to a low level if the THERR signal is a low level (lower than 200° C.). On the other hand, if the THERR signal is a high level (higher than 200° C.), the ASIC circuit 202b outputs the MASK signal as a one-half frequency divided signal (duty 50% pulse signal) of the ZEROX signal. The switching determination is confirmed by the one-half frequency divided rising edge of the ZEROX signal. A transistor 426 operates according to the MASK signal from the ASIC circuit 202b through the resistance 427. The transistor 426 turns on when the MASK signal is a low level and is controlled by an ON signal output by the CPU 202a. The transistor 426 is turned off when the MASK signal is a high level, and the conduction to the heater 301 is turned off regardless of the ON signal. Therefore, the MASK signal becomes a duty 50% pulse if the THERR signal is a high level, and the conduction to the heater 301 is limited to 50% even if an attempt is made for 100% conduction by the ON signal. The safety circuit limits the conduction to 50% if the temperature detected by the temperature detection element 311 exceeds 200° C.

[Phase Control, Wave Number Control, and Phase/Wave Number Combination Control]

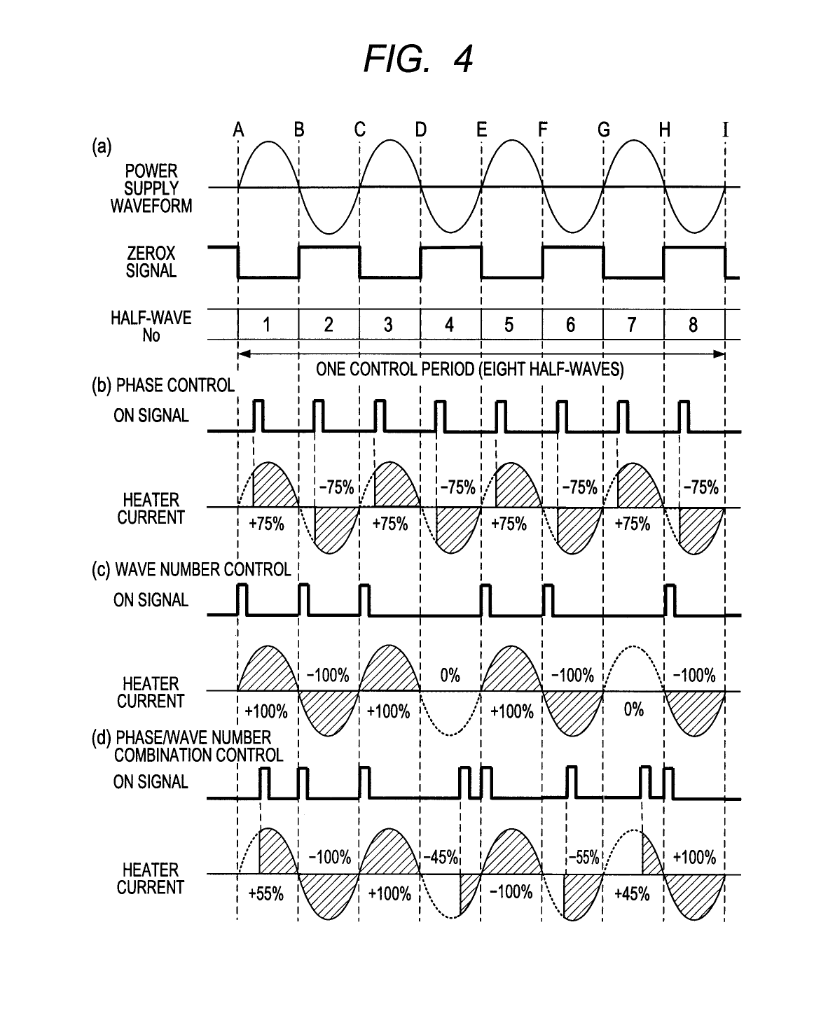

FIG. 4(a) illustrates a power supply waveform of the AC power supply 401, a ZEROX signal, and half-wave numbers (hereinafter, “half-wave No.”) providing numbers to eight half-waves of one control period. FIGS. 4(b) to 4(d) are control explanatory views of phase control, wave number control, and phase/wave number combination control that are power control systems of the heater 301 under the circumstances. FIG. 4 is also a diagram supplementarily describing a conventional control method. The present embodiment illustrates an example of control in which one control period includes eight half-waves, and the heater 301 is conducted at charge power 75%. As illustrated in Table 1, the charge power is determined for eight half-waves in relation to the 75% charge power to be output, and 75% power is output as an average of the entire eight half-waves of the control period. The control of the charge power of each half-wave varies depending on the control system even if the charge power is the same, and each control will be described with reference to FIG. 4.

TABLE 1
Table of Control Method and Example of Power Charge

| | Charge Power | Charge Power of Each Half-Wave No. | | | | | | | | Average |
|---|---|---|---|---|---|---|---|---|---|---|
| Control | (%) | No. 1 | No. 2 | No. 3 | No. 4 | No. 5 | No. 6 | No. 7 | No. 8 | Power |
| Phase | 75 | 75 | 75 | 75 | 75 | 75 | 75 | 75 | 75 | 75 |
| Wave Number | 75 | 100 | 100 | 100 | 0 | 100 | 100 | 0 | 100 | 75 |
| Combination | 75 | 55 | 100 | 100 | 45 | 100 | 55 | 45 | 100 | 75 |

FIG. 4(b) is an example of the phase control. The logic of the ZEROX signal switches at an edge (hereinafter, called “zero cross point”) where the AC power supply 401 switches from positive to negative or from negative to positive. If a heater drive signal (ON signal in FIG. 4(b)) is turned on after a predetermined time from the rising of the edge and from the falling edge of the ZEROX signal, the heater 301 is conducted from that point. A current (described “heater current” in FIG. 4(b)) flows at the parts illustrated by oblique lines of FIG. 4(b), and power is supplied. After the heater 301 is turned on, the conduction to the heater 301 is turned off at the next zero cross point. Therefore, the same power is supplied to the heater 301 at the next half-wave by turning on the heater drive signal again after a predetermined time from the edge of the ZEROX signal. The conduction time to the heater 301 changes when the time (can also be stated “phased angle”) for turning on the heater drive signal is changed, and the supplied power to the heater 301 can be controlled. In the present embodiment, for example, the CPU 202a in the engine controller 202 includes conversion data of the charge power and the phase angle as in Table 2. The firmware mounted on the CPU 202a determines the phase angle based on the control table and controls the power by the ON signal while monitoring the ZEROX signal. The charge power is 75% in Table 1 and FIG. 4(b), which is an example of conduction at a phase angle 66.17°. The charge power is 75% in all eight half-waves in the phase control, and the average of the eight half-waves of one control period is also 75%. The engine controller 202 determines the charge power to the heater 301 by PI control based on the TH signal, i.e. the temperature detected by the temperature detection element 311, to attain the target temperature for fixing.

TABLE 2
Table of Charge Power and Phase Angle Conversion

| Charge Power Duty (%) | Phase Angle α (°) |
|---|---|
| 100 | 0 |
| 97.5 | 28.56 |
| . | . |
| . | . |
| . | . |
| 75 | 66.17 |
| . | . |
| . | . |
| . | . |
| 50 | 90 |
| . | . |
| . | . |
| . | . |
| 25 | 113.83 |
| . | . |
| . | . |
| . | . |
| 2.5 | 151.44 |
| 0 | 180 |

FIG. 4(c) is an example of the wave number control. The on/off control is performed by half-wave of the AC power supply in the wave number control. When the heater 301 is conducted, the heater drive signal (ON signal) is turned on at the edge of the ZEROX signal, and the half-wave is 100% supplied (for example, half-wave No. 1). When the heater 301 is not conducted, the heater drive signal remains off, and the half-wave becomes 0% (for example, half-wave No. 4). In the example of the wave number control illustrated in Table 1 and FIG. 4(c), the power is charged 100%, 100%, 100%, 0%, 100%, 100%, 0%, and 100% for the half-waves, and the average is 75%. FIG. 4(d) is an example of the phase/wave number combination control. FIG. 4(d) illustrates combined control within one control period, in which some half-waves are subjected to the phase control, and some half-waves are subjected to the wave number control. The power is charged 55%, 100%, 100%, 45%, 100%, 55%, 45%, and 100% for the half-waves, and the average is 75%. Since the phase control is not performed in every half-wave in the phase/wave number combination control system, the flowing harmonic current can be reduced. The variable period of the current can be reduced because the control period can be shorter than in the wave number control, and the flicker can be reduced. In FIGS. 4(b) to 4(d), patterns are formed so that the same charge power forms a pair in the control period in odd-numbered positive half-waves and even-numbered negative half-waves. As a result, a positive and negative symmetry is formed, and the request of the prohibition of the asymmetric control is satisfied.

[Operation of Safety Circuit]

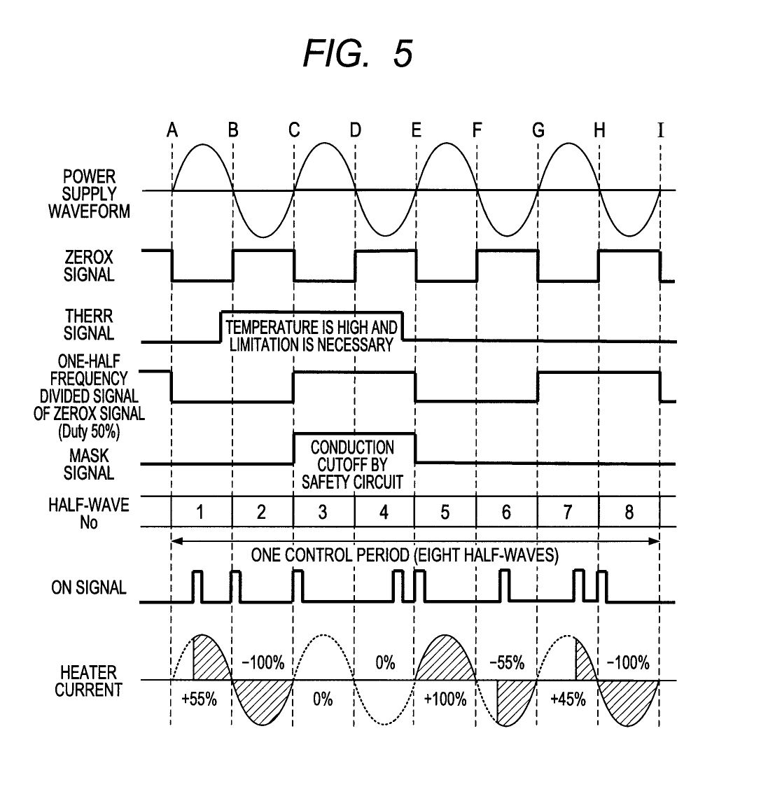

FIG. 5 describes an operation of the safety circuit based on the hardware circuit. The conventional problem will also be supplementarily described. As described in FIG. 3, the THERR signal is a high level if the temperature detected by the temperature detection element 311 is higher than 200° C. (when the temperature is high, and the conduction needs to be limited), and the THERR signal is a low level if the temperature is lower than 200° C. The frequency dividing circuit 202c creates a one-half frequency divided signal (duty 50%) of the ZEROX signal. The ASIC circuit 202b of the engine controller 202 processes the THERR signal and the one-half frequency divided signal of the ZEROX signal into a MASK signal and outputs the MASK signal. Specifically, if the THERR signal is a high level at the rising edge of the one-half frequency divided signal of the ZEROX signal, the MASK signal is output as a high level. If the THERR signal is a low level, the MASK signal is output as a low level. At the falling edge of the one-half frequency divided signal of the ZEROX signal, the MASK signal is output as a low level regardless of the THERR signal. The heater 301 is not conducted if the MASK signal is a high level in FIG. 3. Therefore, if the temperature is high, the conduction is limited to duty 50% in terms of hardware in the one-half frequency divisions of the ZEROX signal. Therefore, during 75% power control based on the phase/wave number combination control illustrated in FIG. 4(d), the safety circuit cuts off the conduction even if the firmware mounted on the CPU 202a of the engine controller 202 attempts the conduction by the ON signal. More specifically, as illustrated in FIG. 5, the safety circuit cuts off the conduction by the MASK signal in a third half-wave (section of C to D of the power supply waveform (half-wave No. 3)) and a fourth half-wave (section of D to E of the power supply waveform (half-wave No. 4)) even if the CPU 202a outputs the ON signal. When the control period of the entire eight half-waves is observed, the third half-wave and the fourth half-wave are not conducted. Therefore, the same charge power does not form pairs in the odd-numbered positive half-waves and the even-numbered negative half-waves, and the positive and negative symmetry is not formed.

Therefore, the request of the prohibition of the asymmetric control of the immunity standards cannot be satisfied. The safety circuit is activated after the rise in the temperature during abnormalities, such as firmware overrun, failure of the temperature detection element, and failure of the conduction circuit. However, the safety circuit may be activated during normal printing. For example, the temperature may be slightly over 200° C. when the fixing target temperature is high in a case of thick paper, or the safety circuit may falsely detect that the temperature of the temperature detection element 311 is over 200° C. due to noise. Furthermore, the temperature may exceed 200° C. when the heat of the heater 301 is not easily released to the pressuring roller 124 after the termination of the rotation of the pressuring roller 124 at the end of the printing. Furthermore, the sheet may be multi-fed in the transfer of the sheet S, and the fixing film 123 and the pressuring roller 124 may not be adhered at a non-sheet feeding section. As a result, the heat of the heater 301 is not easily released to the pressuring roller 124, and the temperature may exceed 200° C. The multi-feeding of sheet denotes a state in which a plurality of pieces of sheet is transferred on top of each other without being separated. Furthermore, the sheet S may be put to the side toward the edge without being stored at the center section of the sheet feeding cassette 112 where the center is the standard. As a result, the sheet S does not pass through the position of the temperature detection element 311, and the temperature may exceed 200° C. because the sheet S does not take the heat away.

### Control During Safety Circuit Operation of the Present Embodiment

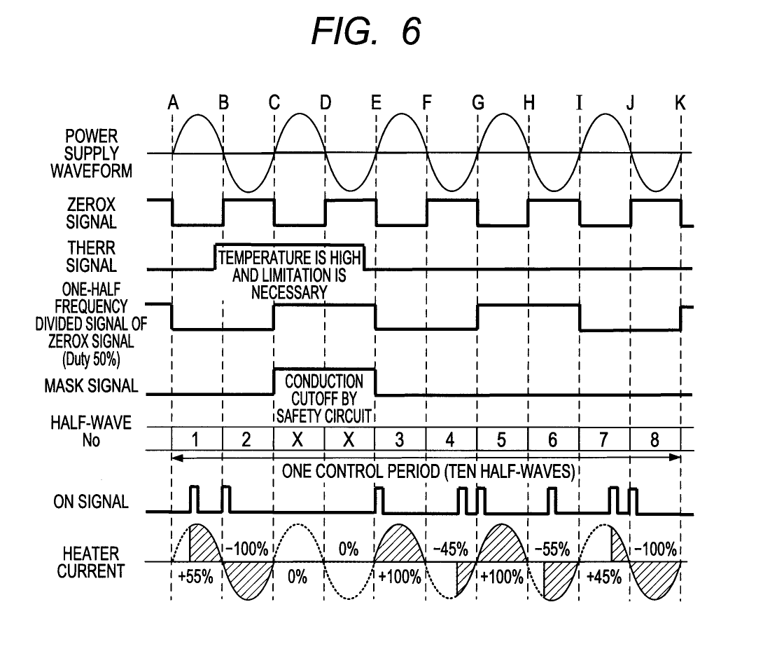

FIG. 6 describes a control method for forming a positive and negative symmetry even if the safety circuit is activated in the present embodiment. FIG. 6 is a diagram in which the conditions when the safety circuit is activated in FIG. 5 are set to form the positive and negative symmetry based on the control of the present embodiment. The MASK signal is input to the CPU 202a of the engine controller 202, and the firmware mounted on the CPU 202a checks the level of the MASK signal at the zero cross point. The CPU 202a outputs a conduction pattern of half-waves to the ON signal if the MASK signal is a low level because the safety circuit is not activated. On the other hand, if the MASK signal is a high level, the CPU 202a leaves the ON signal off and does not conduct power because the safety circuit is activated. The CPU 202a outputs the conduction pattern of the following half-waves to the ON signal when the MASK signal becomes a low level after the release of the high level at the zero cross point and extends the control period. As illustrated in FIG. 6, the ON signal is turned off without conducting the power in the third half-wave (part with an “X mark” at the section of C to D of the power supply waveform) and the fourth half-wave (part with an “X mark” at the section of D to E of the power supply waveform) where the MASK signal is a high level. The output is restarted from a fifth half-wave (section of E to F of the power supply waveform (half-wave No. 3)) where the MASK signal is released to a low level, which is assumed to be the output of the pattern of the third half-wave following the second half-wave (half-wave No. 2). Therefore, the control period is extended to ten half-waves in this case, and the pattern of all eight half-waves is output. As a result, the positively and negatively symmetric control is applied to the new control period of ten half-waves, and the request of the prohibition of the asymmetric control can be satisfied. Although an example of the phase/wave number combination control of FIG. 4(d) is illustrated in the present embodiment, the positively and negatively symmetric control is not applied to the wave number control of FIG. 4(c) if there is a conduction limitation of the safety circuit in the third half-wave and the fourth half-wave in the control period as illustrated in FIG. 5. Therefore, the control of FIG. 6 can be applied to the wave number control of FIG. 4(c) to apply the positively and negatively symmetric control, and the control of the present embodiment is also effective in the wave number control.

### Heater Conduction Control of the Present Embodiment

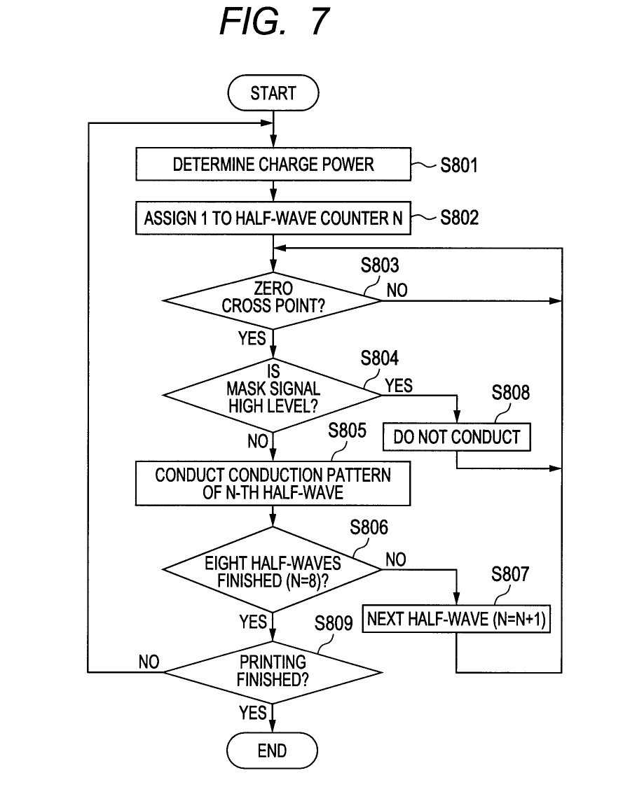

FIG. 7 is a flow chart illustrating heater conduction control in a control period in the engine controller 202. When printing is started, the CPU 202a of the engine controller 202 determines the charge power by the PI control based on the TH signal as an output of the fixing target temperature and the temperature detected by the temperature detection element 311 in step (hereinafter, “S”) 801. In S802, the CPU 202a sets a half-wave counter N to 1 (first half-wave (half-wave No. 1), assigns 1 to N) indicating which number of half-wave of the output pattern among all eight half-waves in the control period will be output. In S803, the CPU 202a waits for the zero cross point based on the ZEROX signal output by the zero cross detection circuit 417. If the CPU 202a determines that the zero cross point has arrived in S803, the CPU 202a determines whether the MASK signal of the safety circuit output by the ASIC circuit 202b is a high level in S804. If the CPU 202a determines that the MASK signal is a low level in S804, the CPU 202a conducts the conduction pattern of the first half-wave by the ON signal in S805. If the CPU 202a determines in S806 that the output of all eight half-waves of the control period is not finished, i.e. N is not 8, the CPU 202a adds 1 to the half-wave counter N (N=N+1) in S807 so that the next half-wave can be output. The CPU 202a returns to the process of S803 and waits for the next zero cross point.

If the CPU 202a determines that the MASK signal of the safety circuit is a high level in S804, the CPU 202a leaves the ON signal off and does not conduct power in the half-wave in S808. The CPU 202a returns to the process of S803 and waits for the next zero cross point. In this case, since the half-wave counter N is not counted up, the CPU 202a waits until the MASK signal becomes a low level at the zero cross point and outputs the following half-wave. If the CPU 202a determines that the output of all eight half-waves in the control period is finished in S806, the CPU 202a returns to S801 to control the temperature of the fixing device 110 in the control period until the CPU 202a determines that the printing is finished in S809. The CPU 202a ends the control if the CPU 202a determines that the printing is finished in S809. In the present embodiment, the conduction is terminated without advancing the half-wave counter N in the period that the MASK signal is a high level in which the safety circuit is activated in the control period, and the output is started from the following half-wave counter when the MASK signal is released to a low level. An example of another embodiment includes a method of advancing the half-wave counter N even in a period that the MASK signal is a high level, but instead, the half-wave number that cannot be output is stored in a storage unit, such as a ROM. In this case, after the output of the eight half-wave as the control period, the half-wave of the half-wave number stored as the half-wave that cannot be output can be output to obtain the same effect.

In the example described in the present embodiment, the control period includes eight half-waves, the power is cut off by the MASK signal in the third half-wave, and the remaining six half-waves are supplied after the release of the cutoff. Assuming that the control period includes N half-waves (N: integer) and that the power is cut off by the MASK signal at an M-th half-wave (M: integer), the remaining (N-M+1) half-waves following an (M−1)-th halve-wave can be conducted after the release of the cutoff.

As described, according to the present embodiment, the safety circuit that limits the conduction by the hardware circuit based on the temperature detection can apply the positively and negatively symmetric control even if the safety circuit is activated during normal printing other than during abnormalities such as a failure. More specifically, the control for making the power supplied in the positive half-waves and the power supplied in the negative half-waves symmetric in the control period is possible even if the safety circuit based on the hardware circuit is activated.

### Second Embodiment

A printer including a fixing device of a second embodiment will be described. The heat of the heater 301 is supplied to the sheet S passing through the pressuring roller 124 or the fixing nip portion N through the fixing film 123. If the pressuring roller 124 is not rotating, it is difficult to transmit the heat to the pressuring roller 124 compared to when the pressuring roller 124 is rotating, because the same position touches the heater 301 in the circumferential direction of the pressuring roller 124. Therefore, only a part in the circumferential direction of the pressuring roller 124 may be overheated, or the heat of the heater 301 may not be easily released, which may cause damage to the fixing device. The present embodiment provides a safety circuit that limits the conduction to the heater 301 to 75% when the pressuring roller 124 is not rotating. FIGS. 1, 2, 4, and 7 are the same as in the first embodiment, and the description will not be repeated. The same reference numerals will be used in the following description.

[Drive Control Circuit of Fixing Heater 111]

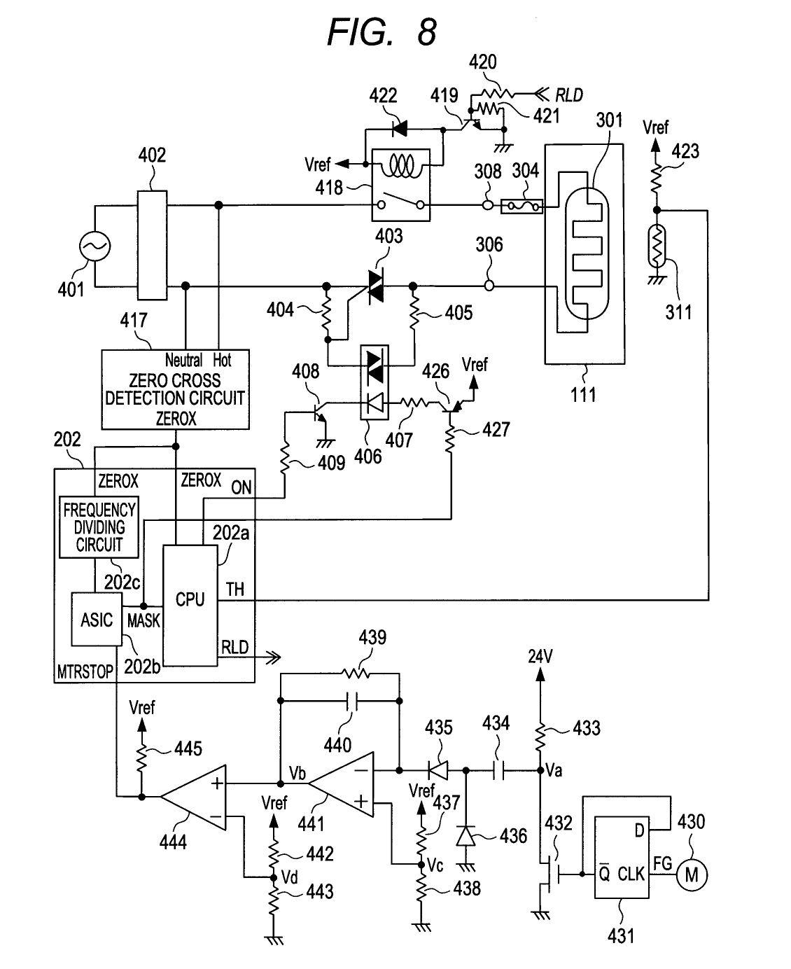

FIG. 8 is a drive control circuit diagram of the fixing heater 111 of the present embodiment. The description of the same circuit parts as in FIG. 3 of the first embodiment will not be repeated, and a safety circuit based on a hardware circuit different from the first embodiment will be described. In the first embodiment, the comparator 429 compares the TH signal (temperature signal) as a detection result of the temperature detection element 311 and the reference voltage equivalent to the reference temperature to output the THERR signal to the engine controller 202 to control the cutoff of the conduction by the safety circuit. In the present embodiment, a number of rotations detection unit outputs an MTRSTOP signal, which indicates whether or not the pressuring roller 124 is rotating based on a rotation signal (FG signal described below) of the pressuring roller 124, and the cutoff of the conduction by the safety circuit is controlled by the MTRSTOP signal. A fixing motor 430 rotates the pressuring roller 124 and outputs a motor rotation detection FG signal (hereinafter, simply called “FG signal”) in association with the rotation. The FG signal output by the fixing motor 430 is input to a D flip-flop 431 to divide the frequency into ½, and the FG signal is supplied to the gate of an FET 432. A rectangular wave Va is applied to a capacitor 434 based on a switching operation of the FET 432. In the present embodiment, the rectangular wave Va has a 24V amplitude. The rectangular wave Va is supplied to an inverting input of an operational amplifier 441 through a diode 435. The operational amplifier 441, a resistance 439, and a capacitor 440 form an integration circuit. The supplied rectangular wave is converted to a DC signal and output from the operational amplifier 441. Assuming that a non-inverting input voltage of the operational amplifier 441 is Vc (determined by resistances 437 and 438), an electrostatic capacity of the capacitor 434 is C434, a resistance value of the resistance 439 is R439, and a frequency of the FG signal is f, an output voltage Vb of the operational amplifier 441 is expressed by the following formula.

Vb=Vc−(24−Vc)×C434×R439×f/2

According to the formula, Vb is dependent on the frequency of the FG signal, and the greater the frequency of the FG signal, the smaller Vb. The output voltage Vb of the operational amplifier 441 is input to a non-inverting input of a comparator 444. The comparator 444 compares reference voltages Vd and Vb determined by resistances 442 and 443. Resistances 433 and 445 are current limitation resistances, and a diode 436 is an element that absorbs the back electromotive voltage. Therefore, the MTRSTOP signal as an output of the comparator 444 becomes a low level if the frequency of the FG signal is higher than a predetermined value and becomes a high level if the frequency of the FG signal is lower than a predetermined value. More specifically, the MTRSTOP signal is a low level if the rotation of the fixing motor 430 is greater than a predetermined number of rotations and is a high level if the rotation of the fixing motor 430 is smaller than a predetermined number of rotations or if the rotation is terminated. As for the rotation determination detection of the fixing motor 430, the FG signal may be input to the ASIC circuit 202b, and the rotation may be detected in the ASIC circuit 202b. Although the FG signal of the fixing motor 430 is used for the rotation detection of the pressuring roller 124, a rotational encoder may be arranged on the pressuring roller 124 to use a rotation signal of the encoder.

The MTRSTOP signal output from the comparator 444 is input to the ASIC circuit 202b of the engine controller 202. A one-half frequency divided signal and a one-quarter frequency divided signal obtained by the frequency dividing circuit 202c dividing the ZEROX signal are input to the ASIC circuit 202b. A negative logic duty 75% signal, which is a logical product of the one-half frequency divided signal and the one-quarter frequency divided signal, is generated. The ASIC circuit 202b always sets the MASK signal to a low level if the MTRSTOP signal is a low level (rotation of the fixing motor 430 is greater than the predetermined number of rotations). The ASIC circuit 202b outputs the MASK signal as a negative logic duty 75% pulse signal if the MTRSTOP signal is a high level (rotation of the fixing motor 430 is smaller than the predetermined number of rotations or the rotation is terminated). The determination of the switching is confirmed by the rising edge of the negative logic duty 75% pulse signal. Therefore, if the MTRSTOP signal is a high level, the MASK signal becomes a negative logic duty 75% pulse. The conduction to the heater 301 is limited to 75% even if the CPU 202a attempts the 100% conduction by the ON signal. The safety circuit limits the conduction to 75% when the rotation of the pressuring roller 124 is smaller than the predetermined number of rotations or when there is no rotation.

### Operation of Safety Circuit and Control During Safety Circuit Operation of the Present Embodiment

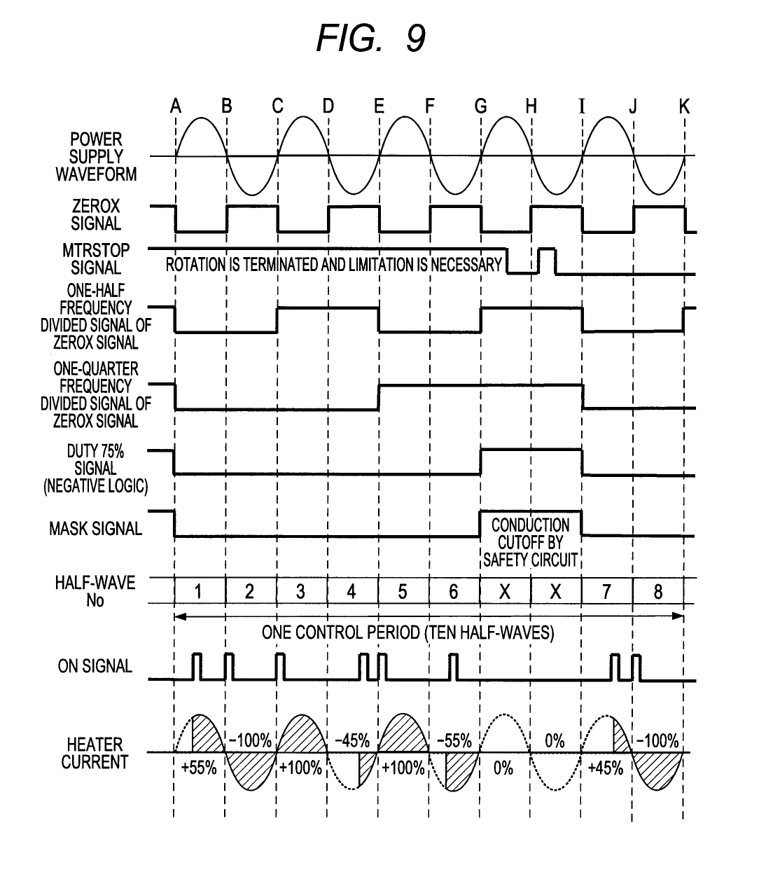

FIG. 9 describes an operation of a safety circuit based on a hardware circuit and a control method for forming a positive and negative symmetry. FIG. 9 also supplementarily describes the conventional problem. As described in FIG. 8, the MTRSTOP signal is a high level if the rotation of the fixing motor 430 is smaller than the predetermined number of rotations or if the rotation is terminated (conduction limitation is necessary) and is a low level if the rotation is greater than the predetermined number of rotations. The frequency dividing circuit 202c outputs the one-half frequency divided signal and the one-quarter frequency divided signal of the ZEROX signal as well as the negative logic duty 75% signal which is a logical product of the signals. The ASIC circuit 202b of the engine controller 202 processes the MTRSTOP signal and the negative logic duty 75% signal into a MASK signal and outputs the MASK signal. Specifically, the MASK signal is output as a high level if the MTRSTOP signal is a high level at the rising edge of the negative logic duty 75% signal, and the MASK signal is output as a low level if the MTRSTOP signal is a low level. The MASK signal is output as a low level regardless of the MTRSTOP signal at the falling edge of the negative logic duty 75% signal. The power is not conducted to the heater 301 if the MASK signal is a high level. Therefore, the conduction is limited to duty 75% in terms of hardware if the rotation of the fixing motor 430 is smaller than the predetermined number of rotations or if the rotation is terminated. Therefore, the heater current is as illustrated in FIG. 9 during the 75% power control based on the phase/wave number combination control of FIG. 4(c) described in the first embodiment. More specifically, the conduction of a seventh half-wave (X mark at a section of G to H of the power supply waveform) and an eighth half-wave (X mark at a section of H to I of the power supply waveform) is cut off by the safety circuit based on the MASK signal even if the firmware mounted on the CPU 202a of the engine controller 202 attempts the conduction by the ON signal. When the entire eight half-waves as one control period are observed, the seventh half-wave and the eighth half-wave are not conducted under the conditions. Therefore, the same charge power does not form pairs in the odd-numbered positive half-waves and the even-numbered negative half-waves, and the positive and negative symmetry is not formed. Therefore, the request of the prohibition of the asymmetric control cannot be satisfied.

In the present embodiment, the MASK signal is input to the CPU 202a of the engine controller 202. The firmware mounted on the CPU 202a checks the level of the MASK signal at the zero cross point. If the MASK signal is a low level, the CPU 202a outputs the conduction pattern of the half-waves to the ON signal because the safety circuit is not activated. If the MASK signal is a high level, the CPU 202a leaves the ON signal off and does not conduct power because the safety circuit is activated. The CPU 202a outputs the conduction pattern of the following half-waves to the ON signal when the MASK signal becomes a low level after the release of the high level at the zero cross point and extends the control period. As illustrated in FIG. 9, the CPU 202a turns off the ON signal at the seventh half-wave (part with an “X mark” at the section of G to H of the power supply waveform) and the eighth half-wave (part with an “X mark” at the section of H to I of the power supply waveform) where the MASK signal is a high level to cut off the conduction. The CPU 202a restarts the output (conduction) from the pattern of the seventh half-wave (half-wave No. 7) following the ninth half-wave (section of I to J of the power supply waveform) where the MASK signal is released to a low level. The control period is extended to ten half-waves in this case, and the pattern of all eight half-waves is output. As a result, the positively and negatively symmetric control is applied to the new control period of ten half-waves, and the request of the prohibition of the asymmetric control can be satisfied. Although an example of the phase/wave number combination control of FIG. 4(c) is illustrated in the present embodiment, the control is also effective in the wave number control of FIG. 4(b) as in the first embodiment.

The safety circuit is activated during abnormalities, such as the firmware overrun, the failure of the temperature detection element, and the failure of the conduction circuit, when the rotation of the fixing motor 430 is smaller than the predetermined number of rotations or when there is no rotation. However, the safety circuit may be activated during normal printing. For example, the number of rotations may become smaller than the predetermined number of rotations before the rotation reaches the predetermined number of rotations after the start of the rotation of the fixing motor 430 while the temperature of the heater 301 is controlled to reach the target temperature to start printing. The rotation of the fixing motor 430 may start to terminate while the temperature is controlled by lowering the target temperature from the print temperature to the standby temperature to finish printing, and the number of rotations may be smaller than the predetermined number of rotations. In the cleaning of the toner attached to the pressuring roller 124, the pressuring roller 124 is repeatedly rotated and terminated while controlling the temperature for printing and while placing the sheet between the fixing film 123 and the pressuring roller 124. In such a case, the safety circuit may be activated upon the termination of the rotation of the pressuring roller 124.

As described, the positively and negatively symmetric control can be performed according to the present embodiment even if the safety circuit that limits the conduction by the hardware circuit based on the detection of the rotation of the pressuring roller (fixing motor rotation) is activated during the normal printing other than during the abnormalities such as a failure. More specifically, according to the present embodiment, the control for making the power supplied in the positive half-waves and the power supplied in the negative half-waves symmetric in the control period is possible even if the safety circuit based on the hardware circuit is activated.

The temperature detection of the first embodiment and the rotation detection of the present embodiment may be combined to apply the conditions of the conduction limitation by the hardware circuit as follows. More specifically, if the number of rotations of the fixing motor is smaller than the predetermined number of rotations or if the rotation is terminated, the conduction may be limited when the temperature detected by the temperature detection element of the heater exceeds 200° C. If the number of rotations is greater than the predetermined number of rotations, the conduction may be limited when the detected temperature exceeds 225° C. The conduction may be limited based on the difference in the power supply voltage or based on the size of the current value flowing through the heater. Other than 50% and 75%, the conduction limitation may be freely set according to the detection conditions.

### Third Embodiment

A printer including a fixing device of a third embodiment will be described. The present embodiment is an example in which there is a plurality of heaters, such as two heaters. The first and second embodiments are examples of one heater and an A4 sized printer, while the present embodiment is an example of two heaters and an A3 sized printer capable of handling sheet (wide) in a size wider than the A4 size by dividing the section into a center section and an edge section. FIGS. 1A, 1B and 4 are the same as in the first embodiment, and the description will not be repeated. The same reference numerals will be used in the description.

[Configurations of Fixing Device and Heater]

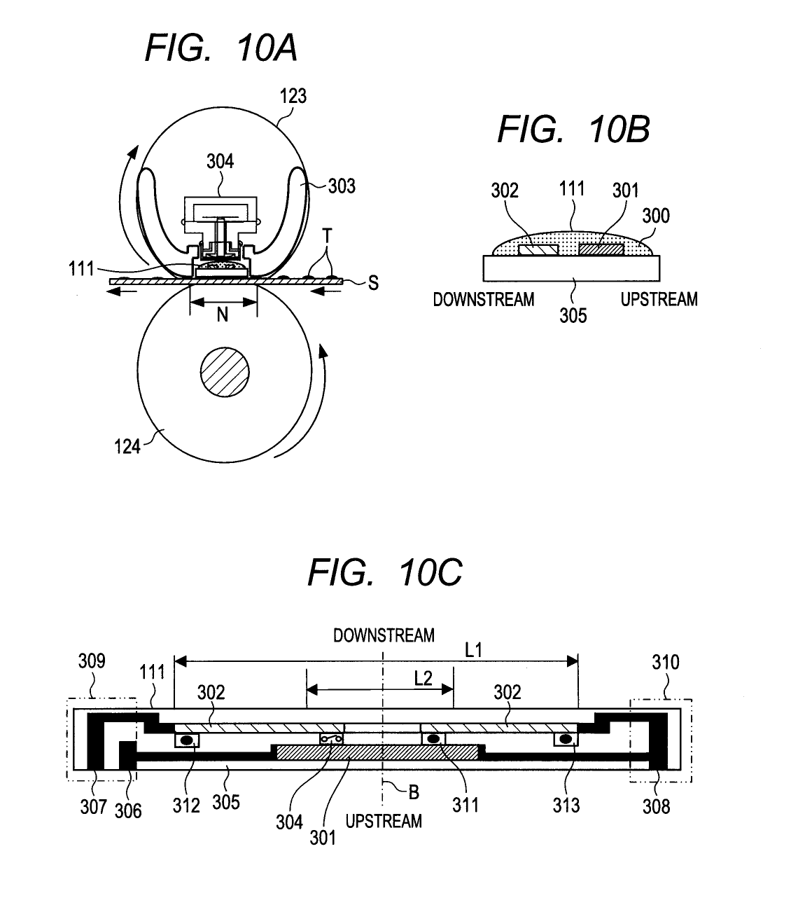

FIGS. 10A to 10C are configuration diagrams of the fixing device of the present embodiment. Parts different from the configuration diagram of FIGS. 2A to 2C in the first and second embodiments will be described. Although the fixing heater 111 includes one heater 301 in the configuration of the first embodiment, the fixing heater 111 of the present embodiment includes two heaters, the heater 301 (also called “main heater”) and a heater 302 (also called “sub heater”). In FIG. 10C, L1 denotes a sheet feeding width area of the maximum sized sheet that can be fed, and L2 denotes a sheet feeding width area of the minimum sized sheet that can be fed. The connector 309 is installed on electrode portions 306 and 307 side of the fixing heater 111 to electrically connect the electrode portions 306 and 307 and the heater drive circuit. The connector 310 is installed on the electrode portion 308 side of the fixing heater 111 to electrically connect the electrode portion 308 and the heater drive circuit. The electrode portion 308 is a common electrode for the two heaters 301 and 302 and is connected to each edge section of the heaters 301 and 302 through branched conduction members. The fixing device 110 includes the temperature detection element 311 that detects the temperature of the center section of the fixing heater 111 and the excessive temperature rise prevention element 304 at the center section on the protection layer 300. The temperature detection element 311 and the excessive temperature rise prevention element 304 are arranged at horizontally symmetric positions relative to the center transfer reference line B of the sheet S, the positions inside the sheet feeding width area L2 of the minimum sized sheet that can be fed. Temperature detection elements 312 and 313 that detect the temperature of the edge sections of the fixing heater 111 are included at the edge sections on the protection layer 300. The temperature detection elements 312 and 313 are arranged at horizontally symmetric positions relative to the center transfer reference B of the sheet S, the positions inside the sheet feeding width area L1 of the maximum sized sheet that can be fed.

As illustrated in FIG. 10C, the main heater 301 is mainly used to heat the center section of the sheet S, and the sub heater 302 is mainly used to heat the edge section of the sheet S. According to the sheet width of the sheet S, only the main heater 301 is conducted if, for example, the width of the sheet S is the minimum width of the sheet feeding width area L2 (conduction ratio of the main heater 301 and the sub heater 302 is set to main 100:sub 0). The main heater 301 and the sub heater 302 are equally conducted if the width of the sheet S is the maximum width of the sheet feeding width area L1 (conduction ratio of the main heater 301 and the sub heater 302 are set to main 100:sub 100). The conduction ratio of the main heater 301 and the sub heater 302 is changed according to the sheet width of the sheet S. The present embodiment is an example in which the main/sub conduction ratio is determined according to the sheet size (sheet width) as for the typical sizes (specifically, as illustrated in Table 3). The main/sub conduction ratio may be set in more details according to the sheet size. For atypical sizes, the main/sub conduction ratio may be set according to a value of the sheet width designated by the user or a value of the sheet width measured by a sheet width detection unit such as a sheet width detection sensor (not illustrated).

TABLE 3
Correspondence Table of Sheet Size and Main/Sub Conduction Ratio

| Sheet Size | Main/Sub Conduction Raito |
|---|---|
| A4 Horizontal, A3 Vertical | Main:Sub = 100:100 |
| LTR Horizontal, LDR Vertical, | Main:Sub = 100:50 |
| B4 Vertical, EXE Horizontal, | |
| B5 Horizontal | |
| LTR Vertical, LGL Vertical | Main:Sub = 100:10 |
| A4 Vertical, A5 Horizontal, | Main:Sub = 100:0 |
| A6 Vertical | |

[Drive Control Circuit of Fixing Heater 111]

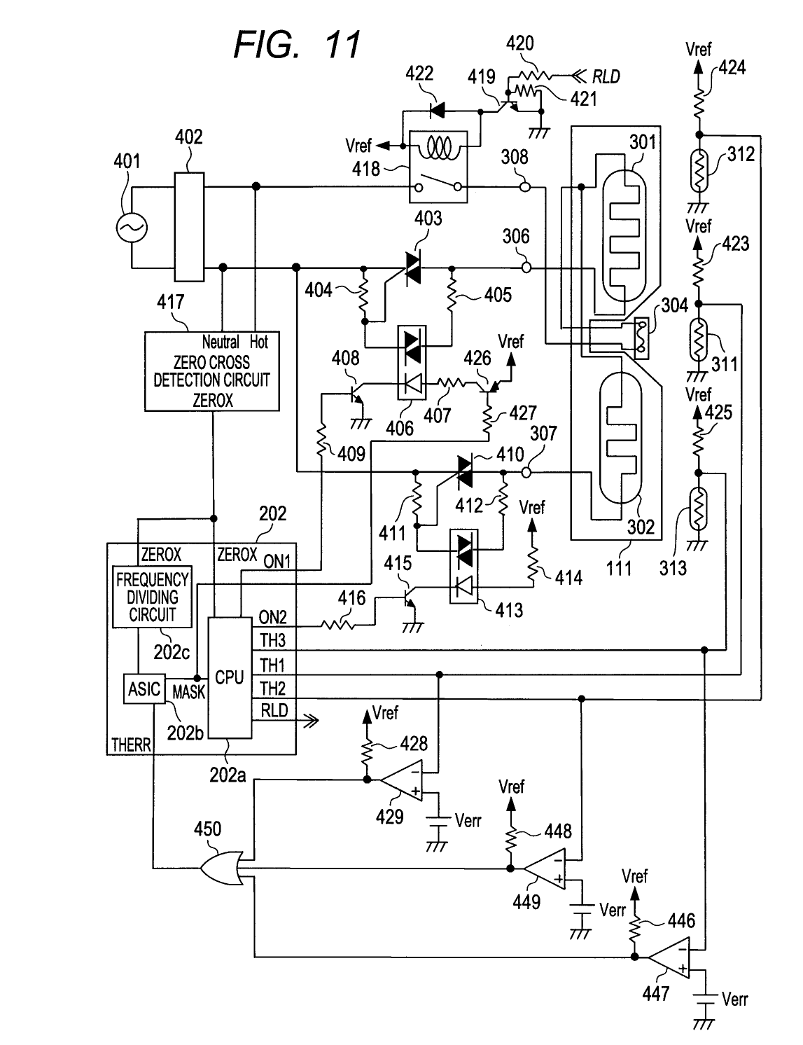

FIG. 11 is a drive control circuit diagram of the fixing heater 111 of the present embodiment. The description of the same circuit parts as in FIG. 3 of the first embodiment will not be repeated, and a safety circuit based on a hardware circuit different from the first embodiment will be described. Since there are two heaters in the present embodiment, the heater 301 of the first embodiment is replaced by the main heater 301 of the present embodiment, and the main heater 301 is driven by an ON1 signal. The same heater drive circuits (reference numerals 410 to 416) are added for the added sub heater 302, and the sub heater 302 is driven by an ON2 signal. The difference between the drive circuit of the main heater 301 and the drive circuit of the sub heater 302 is that the safety circuit of the hardware circuit based on the MASK signal is activated only in the main heater 301. There is only one temperature detection element in the first embodiment, while there are three temperature detection elements in the present embodiment. The detection result of the temperature detection element 311 that measures the temperature at the center section is input to the engine controller 202 as a TH1 signal as in the first embodiment, and the detection results of the temperature detection elements 312 and 313 that measure the temperatures at the edge section are similarly input as TH2 and TH3 signals. The temperatures detected by the temperature detection elements 312 and 313 are detected as partial pressures of resistances 424 and 425 and the temperature detection elements 312 and 313, respectively.

The engine controller 202 monitors the temperatures of the fixing heater 111 as the TH1, TH2, and TH3 signals. The CPU 202a compares the information of the set temperature of the fixing heater 111 set inside the engine controller 202 with the information of the TH1, TH2, and TH3 signals to calculate the power to be supplied to the heaters 301 and 302. The CPU 202a converts the calculated power to be supplied into a phase angle (phase control) or a wave number (wave number control), and the engine controller 202 outputs the ON1 signal to the transistor 408 or outputs the ON2 signal to a transistor 415 based on the control conditions. The engine controller 202 compares the TH1 signal as the temperature information of the center section detected by the temperature detection element 311 with the TH2 signal and the TH3 signal as the temperature information of the edge sections detected by the temperature detection elements 312 and 313. As a result of the comparison, the engine controller 202 continues printing if the temperature difference is within a range of a predetermined temperature (for example, 10° C.) On the other hand, if the temperature difference is out of the range of the predetermined temperature, the engine controller 202 extends the gaps between pieces of sheet (transfer intervals) to drop the throughput and averages the temperatures of the center section and the edge sections.

[Operation of Safety Circuit]

A safety circuit based on a hardware circuit will be described. There is one temperature detection element in the first embodiment. Therefore, the THERR signal is set to a high level if the temperature is over the threshold temperature 200° C. based on the comparator 429. Meanwhile, there are three temperature detection elements in the present embodiment. Therefore, an OR circuit 450 is provided to set the THERR signal to a high level if one of the temperatures is over the threshold temperature 200° C. Although the temperature thresholds are the same at 200° C. in the present embodiment, the reference voltages Verr of the comparators 429, 447, and 449 can be changed in each temperature detection element. Resistances 446 and 448 are current limitation resistances. The THERR signal is input to the ASIC circuit 202b of the engine controller 202. Based on the one-half frequency divided signal of the ZEROX signal, the ASIC circuit 202b always outputs the MASK signal as a low level if the THERR signal is a low level (lower than 200° C.). The ASIC circuit 202b outputs the MASK signal as the one-half frequency divided signal (duty 50% pulse signal) of the ZEROX signal if the THERR signal is a high level (higher than 200° C.). Therefore, if the THERR signal is a high level, the MASK signal becomes a duty 50% pulse. The conduction to the main heater 301 is limited to 50% even if the 100% conduction is attempted by the ON1 signal. The safety circuit limits the conduction of only the main heater 301 to 50% if one of the temperature detection elements exceeds 200° C. In the present embodiment, for example, the power is 700 W when the main heater 301 is driven 100%, and the power is 300 W when the sub heater 302 is driven 100%. The safety can be secured by limiting only the main heater 301 with a greater amount of power supply to 50%. The main heater 301 and the sub heater 302 may be limited to 50% at the same time.

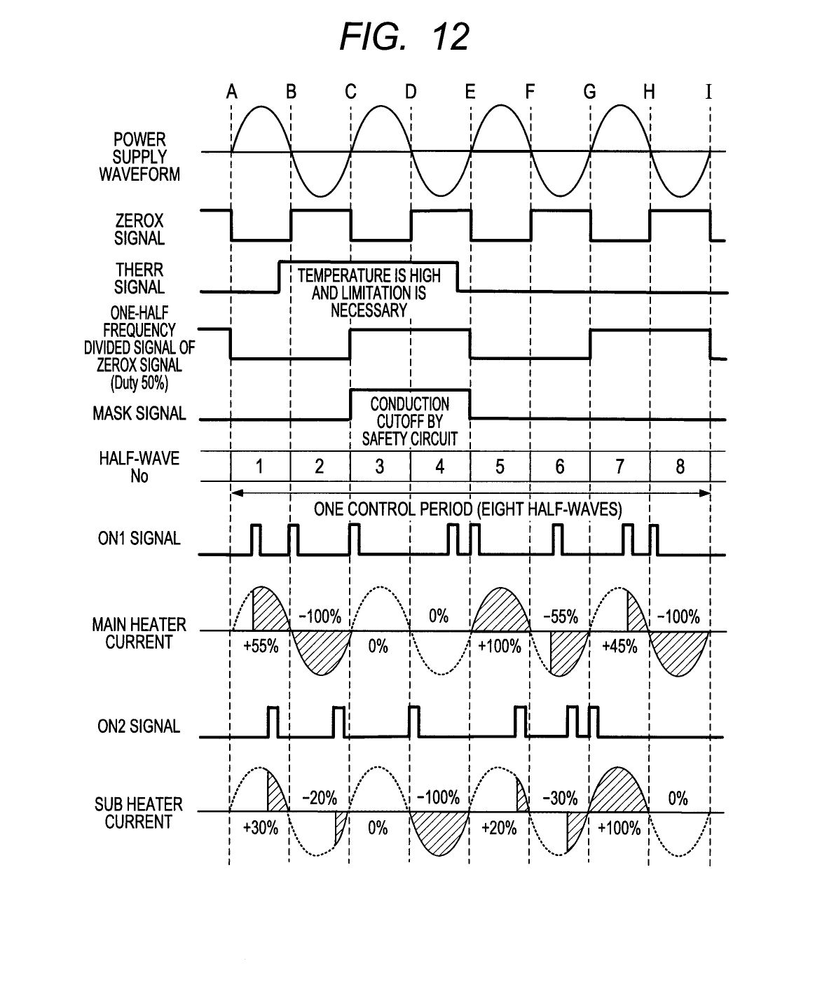

FIG. 12 is a safety circuit operation explanatory view for describing an operation of the safety circuit based on the hardware circuit. FIG. 12 also supplementarily describes the conventional problem. The power control of the main heater 301 and the sub heater 302 will be described. This is an example of control when the power is charged to the main heater 301 and the sub heater 302 in the phase/wave number combination control. As illustrated in Table 4, the charge power is supplied at a main/sub conduction ratio of main 100:sub 50, 75% to the main heater 301 and the half or 37.5% to the sub heater 302. The engine controller 202 selects the main/sub ratio according to the sheet size (main 100:sub 50 in the example) and controls the charge power by PI control based on the temperature information of the TH1 to TH3 signals so that the target temperature to be fixed is attained.

TABLE 4
Table of Example of Main/Sub Power Charge

| Charge Power | | Charge Power of Each Half-Wave No. | | | | | | | | Average |
|---|---|---|---|---|---|---|---|---|---|---|
| (%) | | No. 1 | No. 2 | No. 3 | No. 4 | No. 5 | No. 6 | No. 7 | No. 8 | Power |
| Main | 75 | 55 | 100 | 100 | 45 | 100 | 55 | 45 | 100 | 75 |
| Sub | 37.5 | 30 | 20 | 0 | 100 | 20 | 30 | 100 | 0 | 37.5 |

In the example of Table 4 and FIG. 12, the main heater 301 and the sub heater 302 are output for each half-wave by the phase/wave number combination control as illustrated in Table 4. A pattern is formed so that the same charge power forms pairs in the control period by odd-numbered positive half-wave combinations and even-numbered negative half-wave combinations. As a result, the positive and negative symmetry is provided as a combined current of the main heater 301 and the sub heater 302, and the request of the prohibition of the asymmetric control is satisfied.

The THERR signal is a high level if one of the temperature detection elements 311, 312, and 313 is higher than 200° C. (conduction limitation is necessary) and is a low level if the temperatures are below 200° C. The frequency dividing circuit 202c generates the one-half frequency divided signal (duty 50%) of the ZEROX signal. The ASIC circuit 202b of the engine controller 202 processes the THERR signal and the one-half frequency divided signal of the ZEROX signal into a MASK signal and outputs the MASK signal to the CPU 202a. Specifically, the MASK signal is output in a high level if the THERR signal is a high level at the rising edge of the one-half frequency divided signal of the ZEROX signal, and the MASK signal is output in a low level if the THERR signal is a low level. The ASIC circuit 202b outputs the MASK signal at a low level regardless of the THERR signal at the falling edge of the one-half frequency divided signal of the ZEROX signal. As described in FIG. 11, the main heater 301 is not conducted if the MASK signal is a high level. Therefore, the conduction is limited to duty 50% in terms of hardware in the one-half frequency divisions of the ZEROX signal if the temperature is high. Thus, the following occurs even if the firmware mounted on the CPU 202a attempts the conduction by the ON1 and ON2 signals during the power control of main 75% and sub 37.5% based on the phase-wave number combination control illustrated in Table 4. More specifically, as illustrated in FIG. 12, only the main heater 301 is not conducted by the safety circuit based on the MASK signal in the third half-wave (section of C to D of the power supply waveform) and the fourth half-wave (section of D to E of the power supply waveform). When the entire eight half-waves as one control period are observed, only the main heater 301 of the third half-wave and the fourth half-wave is not conducted. Therefore, the same combined charge power does not form pairs by the odd-numbered positive half-wave combinations and the even-numbered negative half-wave combinations, and the positive and negative symmetry is not formed. Therefore, the request of the prohibition of the asymmetric control cannot be satisfied.

The safety circuit is activated after the rise of the temperature during abnormalities, such as the firmware overrun, the failure of the temperature detection element, and the failure of the conduction circuit. However, the safety circuit may be activated during normal printing. There are examples of the thick paper, noise, at the end of printing, multi-feeding, and putting the sheet to the side described in the first embodiment. Furthermore, there is a case in which the sheet S passes through only the center section of the fixing device 110 to take away heat when sheet with a narrow width is printed in the A3 sized printer, but the sheet S does not take the heat away at the non-sheet feeding section. Therefore, the temperature of the edge section may rise, and the edge section temperature may exceed 200° C.

There is another problem that the average power of the main heater 301 is 56.875%, and the average power of the sub heater 302 is 37.5% if the entire eight half-waves as the control period are observed when the safety circuit is activated. Therefore, the main/sub ratio is main 100:sub 65.9. As a result, the ratio of the sub heater 302 is higher than the main 100:sub 50 which is the conduction ratio selected according to the sheet size. It is empirically known that the enlargement of the ratio of the sub heater 302 increases the temperature of the edge section by 1 to 3° C. compared to the temperature of the center section. If the temperature difference between the center section and the edge section exceeds 10° C., the gaps between pieces of sheet increase, and the throughput drops. Therefore, the enlargement of the temperature difference by 1 to 3° C. may reduce the throughput.

### Control during Safety Circuit Operation of the Present Embodiment

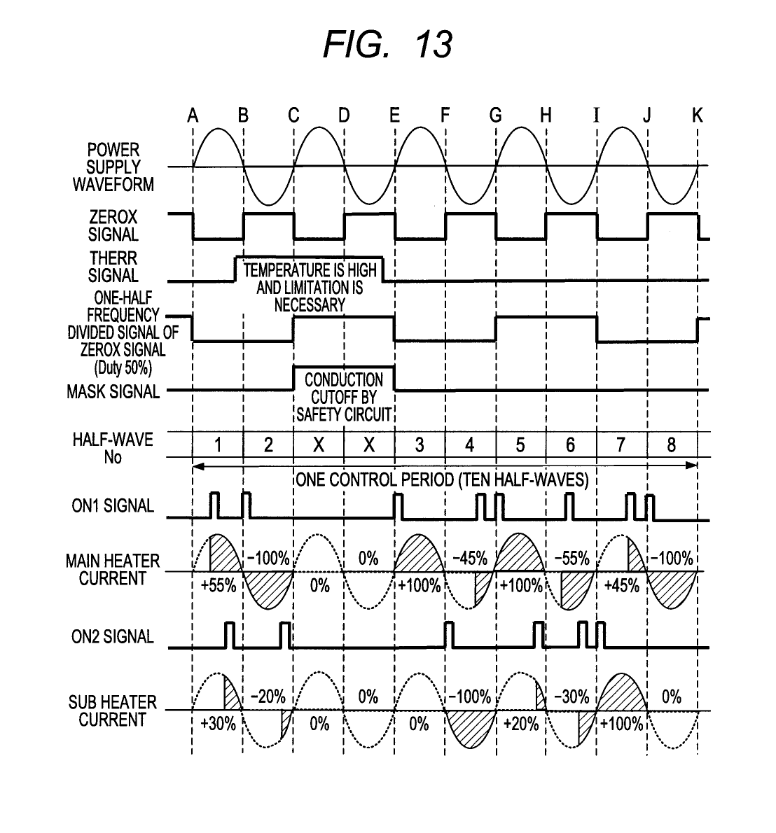

FIG. 13 describes a control method for forming a positive and negative symmetry even if the safety circuit is activated in the present embodiment. In FIG. 13, the conditions when the safety circuit is activated in FIG. 12 are made positively and negatively symmetric by the control of the present embodiment. The MASK signal is input to the CPU 202a of the engine controller 202, and the firmware mounted on the CPU 202a checks the level of the MASK signal at the zero cross point. If the CPU 202a determines that the MASK signal is a low level, the CPU 202a outputs the conduction pattern of the half-waves to the ON1 signal and the ON2 signal because the safety circuit is not activated. If the CPU 202a determines that the MASK signal is a high level, the CPU 202a leaves the ON1 and ON2 signals off and does not conduct the power because the safety circuit is activated. The MASK signal limits the conduction of only the main heater 301, and the sub heater 302 can be conducted by the ON2 signal. However, the main heater 301 and the sub heater 302 are turned off and not conducted here. The conduction pattern of the following half-waves is output to the ON1 and ON2 signals when the MASK signal becomes a low level after the release of the high level at the zero cross point, and the control period is extended. As illustrated in FIG. 13, the CPU 202a turns off the ON1 and ON2 signals at the third half-wave (part with an “X mark” at the section of C to D of the power supply waveform) and the fourth half-wave (part with an “X mark” at the section of D to E of the power supply waveform) where the MASK signal is a high level and does not conduct power. The CPU 202a restarts the output from the pattern of the following third half-wave from the fifth half-wave (section of E to F of the power supply waveform (half-wave No. 3)) where the MASK signal is released to a low level. In this case, the CPU 202a extends the control period from eight half-waves to ten half-waves and outputs the pattern of all eight half-waves. As a result, the conduction pattern indicates the positively and negatively symmetric control in the new control period with ten half-waves, and the request of the prohibition of the asymmetric control can be satisfied. The average power of the main heater 301 is 60%, and the average power of the sub heater 302 is 30% in the new control period with ten half-waves. The main/sub ratio satisfies the ratio of main 100:sub 50. Therefore, the problem of the reduction in the throughput caused by the temperature rise at the edge section can be solved.

### Heater Conduction Control of the Present Embodiment

The flow chart illustrating the heater conduction control in the control period can be described by FIG. 7 as in the first and second embodiments. In step equivalent to S801, the CPU 202a determines the charge power by the PI control based on the fixing target temperature and the detected temperature TH1, TH2, and TH3 signals and determines the main/sub ratio from the sheet size. In step equivalent to S805, the main heater 301 and the sub heater 302 are conducted and output by the charge pattern of the N-th half-wave. In step equivalent to S808, the main heater 301 and the sub heater 302 are not conducted.

Although there are two heaters in the present embodiment, there may be three or more heaters. In this case, the conduction of the heaters is turned off if the safety circuit based on the hardware circuit is activated in one of the heaters, and the heaters are conducted if all heaters can be conducted. The conditions of the safety circuit may be determined not only by the temperature detection, but also in conjunction with the pressuring roller rotation detection as in the second embodiment.

As described, according to the present embodiment, the positively and negatively symmetric control can be performed in the configuration with a plurality of heaters even if the safety circuit that limits conduction based on the hardware circuit is activated during normal printing other than during abnormalities such as a failure. More specifically, the power may be controlled to be symmetric between that supplied in the positive half-waves and that supplied in the negative half-waves in the control period even if the safety circuit based on the hardware circuit is activated. Furthermore, the conduction ratios can effectively be maintained for the plurality of heaters.

### Fourth Embodiment

A fixing device and a printer using the fixing device of a fourth embodiment will be described. The fourth embodiment is an example in which the heater conduction control is changed from the configuration of the first embodiment. In the first embodiment, the control period is changed to attain the positively and negatively symmetric control when the safety circuit based on the hardware circuit is activated. In the present embodiment, the conduction pattern is devised to apply the positively and negatively symmetric control without changing the control period. FIGS. 1 to 4 are the same as in the first embodiment, and the description will not be repeated. The same reference numerals will be used in the description.

### Control during Safety Circuit Operation of the Present Embodiment

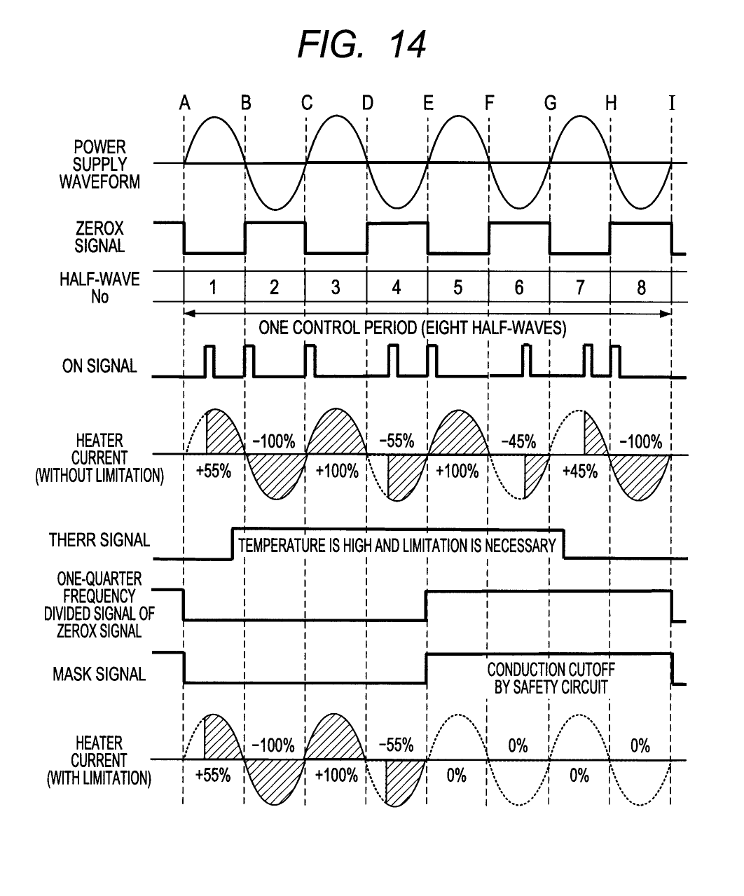

FIG. 14 describes an operation of a safety circuit based on a hardware circuit and a control method for forming a positive and negative symmetry. As described in the first embodiment, the conduction is limited to duty 50% in terms of hardware in the present embodiment because the MASK signal is a high level when the temperature is high. The difference is that while the one-half frequency divided signal duty 50% signal of the ZEROX signal serves as the MASK signal in the first embodiment, a one-quarter frequency divided signal duty 50% signal of the ZEROX signal serves as the MASK signal in the present embodiment. FIG. 14 is an example of charge in the phase/wave number combination control of charge power 75%, and the phase/wave number combination control of Table 1 is improved as in Table 5.

TABLE 5
Table of Example of Power Charge

| Charge Power | Charge Power of Each Half-Wave No. | | | | | | | | Average |
|---|---|---|---|---|---|---|---|---|---|
| (%) | No. 1 | No. 2 | No. 3 | No. 4 | No. 5 | No. 6 | No. 7 | No. 8 | Power |
| 75 | 55 | 100 | 100 | 55 | 100 | 45 | 45 | 100 | 75 |

The phase control is applied to some half-waves, and the wave number control is applied to some half-waves within the control period in the combined control. The power is charged 55%, 100%, 100%, 55%, 100%, 45%, 45%, and 100% for the half-waves, and the average is 75%. A modification from Table 1 is that the first four half-waves are positively and negatively symmetric in the conduction pattern, and the second four half-waves are also positively and negatively symmetric in the conduction pattern. In the MASK signal, a high level and a low level are repeated every four half-waves in the one-quarter frequency divided signal of the ZEROX signal, and the positively and negatively symmetric conduction patterns are formed in four half-waves according to the four half-waves. FIG. 14 is a diagram of conduction based on the conduction pattern of Table 5, and if there is no limitation by the safety circuit, the power is charged as in “heater current (without limitation)” described at the center.

A control method when the safety circuit is activated will be described. The MASK signal and the one-quarter frequency divided signal of the ZEROX signal are input to the CPU 202a of the engine controller 202. Only the MASK signal is input to the CPU 202a in the circuit diagram of FIG. 3, while the one-quarter frequency divided signal of the ZEROX signal is also input from the frequency dividing circuit 202c in the present embodiment. The firmware mounted on the CPU 202a checks the level of the one-quarter frequency divided signal of the ZEROX signal at the zero cross point and performs synchronization so that the fall from a high level to a low level comes at the first half-wave of the eight half-waves of the control period. After the synchronization, the CPU 202a outputs the conduction pattern of the eight half-waves at each zero cross point. As illustrated in “heater current (with limitation)” described at the lower part of FIG. 14, the safety circuit does not conduct power from the fifth half-wave to the eighth half-wave (sections of E to I of the power supply waveform) where the MASK signal is a high level, and the output is 0%. As a result, when the control period of all eight half-waves is observed, the positively and negatively symmetric control is applied, and the request of the prohibition of the asymmetric control is satisfied. Among all eight half-waves of the control period, the first four half-waves and the second four half-waves form positive and negative symmetries in the conduction pattern, and the conduction limitation by the safety circuit is applied four half-waves by four half-waves in the synchronization. As a result, the positively and negatively symmetric control can be realized in the control period without extending the control period. The firmware of the CPU 202a does not have to detect the level of the MASK signal to determine whether to conduct power.

### Heater Conduction Control of the Present Embodiment

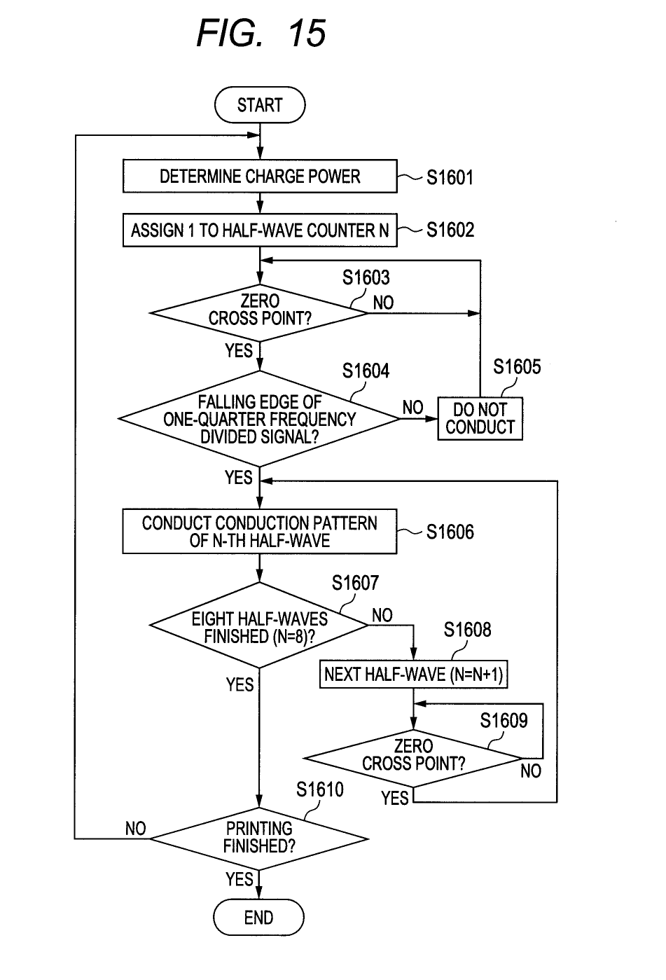

FIG. 15 is a flow chart illustrating heater conduction control in the control period in the engine controller 202. The process of S1601 to S1603 is the same as S801 to S803 of FIG. 7, and the description will not be repeated. In S1604, the CPU 202a determines whether it is a falling edge of the one-quarter frequency divided signal of the ZEROX signal input from the frequency dividing circuit 202c. If the CPU 202a determines that it is not a falling edge of the one-quarter frequency divided signal of the ZEROX signal in S1604, the CPU 202a waits for the next zero cross point without conducting power to wait for the synchronization with the safety circuit in S1605. If the CPU 202a determines that it is a falling edge of the one-quarter frequency divided signal of the ZEROX signal and there is synchronization with the safety circuit at the falling edge in S1604, the CPU 202a conducts the conduction pattern of the first half-wave by the ON signal in S1606. Usually, it is necessary to perform the synchronization just once. If the CPU 202a determines that the output of all eight half-waves is not finished in S1607, the CPU 202a adds 1 to the half-wave counter N in S1608 so that the next half-wave can be output. In S1609, the CPU 202a returns to the process of S1606 at each zero cross point. More specifically, the CPU 202a outputs the ON signal at each zero cross point regardless of the level of the MASK signal. If the safety circuit is activated, the safety circuit cuts off the conduction. The difference in the present embodiment is that there is no process by the CPU 202a determining the signal level of the MASK signal in S804 of FIG. 7 of the first embodiment. S1610 is the same as S809 of FIG. 7.

In the present embodiment, the positively and negatively symmetric conduction pattern includes four half-waves, and the MASK signal includes four half-waves. One control period includes eight half-waves which are twice the four half-waves. The control period may include, for example, sixteen half-waves which are four times the four half-waves. Alternatively, the conduction pattern and the MASK pattern may include six half-waves, and the control period may include twelve half-waves which are twice the six half-waves. Therefore, the MASK signal may include A half-waves (A: even number equal to or greater than 4=4, 6, 8, . . . ) to limit the power supply to the heater 301, and the control period may include (AxB) half-waves which are B times (B: integer equal to or greater than 2=2, 3, 4, . . . ) the A half-waves.

As described above, the positively and negatively symmetric control can be performed without changing the control period even if the safety circuit that limits the conduction by the hardware circuit based on the temperature detection is activated during normal printing other than abnormalities such as a failure. Therefore, according to the present embodiment, the control for making the power supplied in the positive half-waves and the power supplied in the negative half-waves symmetric in the control period is possible even if the safety circuit based on the hardware circuit is activated.

### Fifth Embodiment

A printer including a fixing device of a fifth embodiment will be described. The fifth embodiment is an example in which the heater conduction control is changed from the configuration of the third embodiment including a plurality of heaters. In the third embodiment, the control period is changed to apply the positively and negatively symmetric control when the safety circuit based on the hardware circuit is activated. In the present embodiment, the conduction pattern is devised to perform the positively and negatively symmetric control without changing the control period. FIGS. 1, 4, 10, and 11 are the same as in the third embodiment, and the description will not be repeated. The same reference numerals are used in the description.

[Operation of Safety Circuit]

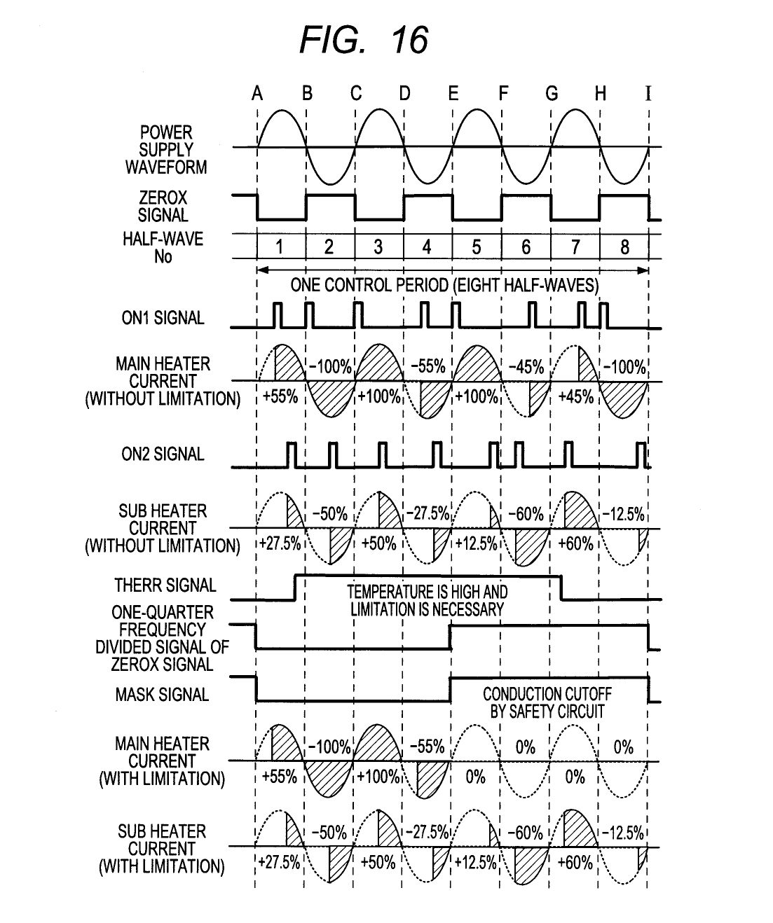

FIG. 16 describes an operation of a safety circuit based on a hardware circuit. As described in the third embodiment, the MASK signal becomes a high level, and the conduction is limited to duty 50% in terms of hardware when the temperature is high in the present embodiment. The difference is that while the one-half frequency divided signal duty 50% signal of the ZEROX signal serves as the MASK signal in the third embodiment, the one-quarter frequency divided signal duty 50% signal of the ZEROX signal serves as the MASK signal in the present embodiment. FIG. 16 of the present embodiment is an example of charge in the phase/wave number combination control of charge power 75%, and the phase/wave number combination control of Table 4 is improved as in Table 6. The ratio of the main heater 301 and the sub heaters 302 and 303 is main 100:sub 50.

TABLE 6
Table of Example of Main/Sub Power Charge

| Charge Power | | Charge Power of Each Half-Wave No. | | | | | | | | Average |
|---|---|---|---|---|---|---|---|---|---|---|
| (%) | | No. 1 | No. 2 | No. 3 | No. 4 | No. 5 | No. 6 | No. 7 | No. 8 | Power |
| Main | 75 | 55 | 100 | 100 | 55 | 100 | 45 | 45 | 100 | 75 |
| Sub | 37.5 | 27.5 | 50 | 50 | 27.5 | 12.5 | 60 | 60 | 12.5 | 37.5 |

The phase control is applied to some half-waves, and the wave number control is applied to some half-waves within the control period in the combined control. The main heater 301 charges 55%, 100%, 100%, 55%, 100%, 45%, 45%, and 100% for the half-waves, and the average is 75%. The sub heaters 302 and 303 charge 27.5%, 50%, 50%, 27.5%, 12.5%, 60%, 60%, and 12.5% for the half-waves, and the average is 37.5% which is a half that of the main heater 301. A modification from Table 4 is that the current is a combined current combining the main and the sub, the first four half-waves are positively and negatively symmetric in the conduction pattern, and the second four half-waves are also positively and negatively symmetric in the conduction pattern. The modification is made so that the main/sub ratio is main 100:sub 50 in the four half-waves. The MASK signal repeats a high level and a low level every four half-waves in the one-quarter frequency divided signal of the ZEROX signal, and in accordance with the four half-waves, the conduction pattern is formed by four half-waves in which there is a main/sub-combined positive and negative symmetry, and the conduction ratio is fixed. FIG. 16 is a diagram of conduction based on the conduction pattern of Table 6. If there is no limitation by the safety circuit, the power is charged as in “main heater current (without limitation)” and “sub heater current (without limitation)” described at the center. A case in which the temperature is high, and the safety circuit is activated will be described. The MASK signal from the safety circuit only acts on the main heater 301. As described at the lower part of FIG. 16, the following occurs when the safety circuit is activated after the MASK signal becomes a high level from the fifth half-wave to the eighth half-wave (sections of E to I of the power supply waveform) of the second half. More specifically, the second half is not conducted only in the main heater 301, and the power is charged as in “main heater current (with limitation)” and “sub heater current (not limited)”. When the entire eight half-waves of the control period are observed, although the positively and negatively symmetric control is possible, the main/sub ratio is main 100:sub 96.8. The charge power to the sub heaters 302 and 303 is large compared to main 100: sub 50 which is the target conduction ratio, and the throughput may drop as a result of the rise in the temperature of the edge section as described in the third embodiment.

### Control During Safety Circuit Operation of the Present Embodiment

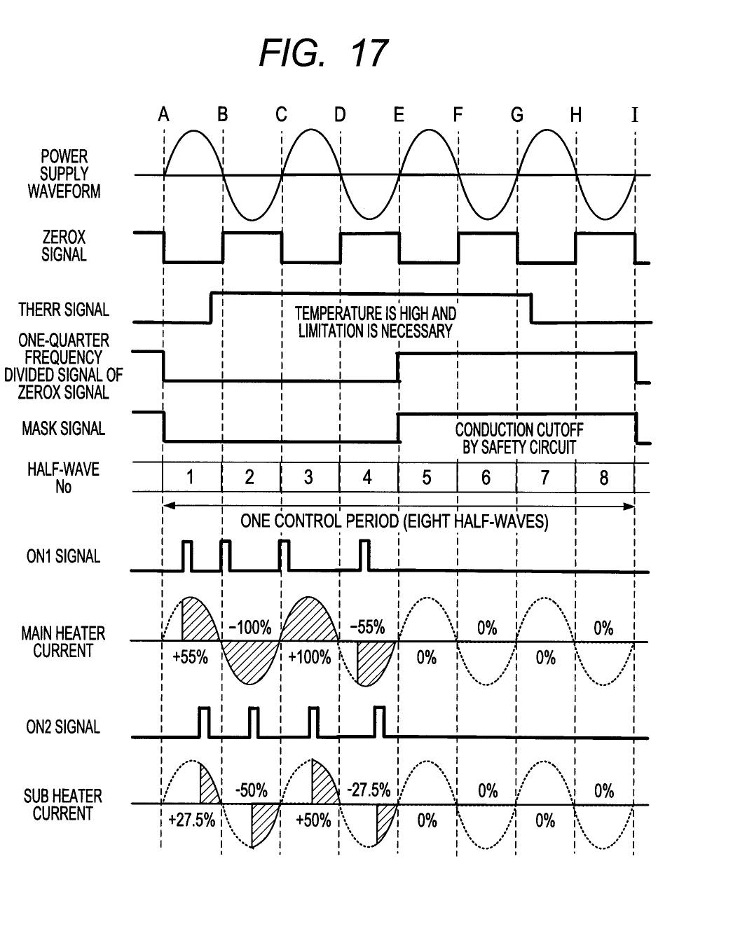

FIG. 17 describes a control method when the safety circuit is activated. The MASK signal and the one-quarter frequency divided signal of the ZEROX signal are input to the CPU 202a of the engine controller 202. Although only the MASK signal is input to the CPU 202a in the circuit diagram of FIG. 11, there is a change in the present embodiment that the one-quarter divided signal of the ZEROX signal is also connected from the frequency dividing circuit 202c. The firmware mounted on the CPU 202a checks the level of the one-quarter frequency divided signal of the ZEROX signal at the zero cross point and performs synchronization so that the fall from a high level to a low level comes at the beginning of the eight half-waves of the control period. After the synchronization, the CPU 202a outputs the conduction pattern of eight half-waves at each zero cross point. However, the MASK signal is checked when the conduction pattern of each half-wave is output, and if the MASK signal is a low level and the safety circuit is not activated, the conduction pattern is output by the ON1 signal and the ON2 signal. If the MASK signal is a high level and the safety circuit is operated, the power is not conducted by turning off the ON1 signal and the ON2 signal. As described in FIG. 17, the following occurs when the safety circuit does not conduct power from the fifth half-wave to the eighth half-wave (sections of E to I of the power supply waveform) where the MASK signal is a high level. More specifically, the ON1 signal and the ON2 signal are turned off, and the power is not conducted to the main heater 301 and the sub heaters 302 and 303. As a result, when the control period of all eight half-waves is observed, not only can the positively and negatively symmetric control be applied, but also the conduction ratio of the main and the sub can be set to main 100:sub 50.

### Heater Conduction Control of the Present Embodiment

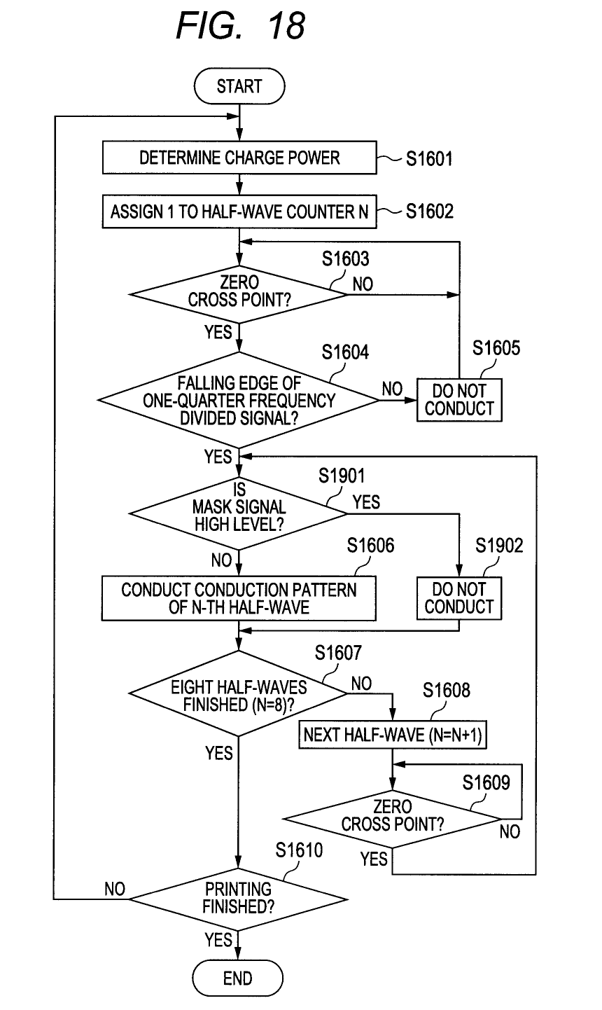

FIG. 18 is a flow chart illustrating heater conduction control in the control period in the engine controller 202. The difference from FIG. 15 of the fourth embodiment is that S1901 and S1902 are added. From S1601 to S1605 are the same as in the fourth embodiment, and the description will not be repeated. In S1901, the CPU 202a checks the level of the MASK signal. If the CPU 202a determines that the MASK signal is a low level, the CPU 202a conducts the conduction pattern of the first half-wave by the ON1 signal and the ON2 signal in S1606. If the CPU 202a determines that the MASK signal is a high level in S1901, the CPU 202a does not conduct the ON1 signal and the ON2 signal in S1902. From S1607 to S1610 are the same as in the fourth embodiment, and the description will not be repeated.

In the present embodiment, the conduction pattern with a positive and negative symmetry and with a fixed conduction ratio of a plurality of heaters includes four half-waves, and the MASK signal also includes four half-waves. One control period includes eight half-waves which are twice the four half-waves. However, the control period may include, for example, sixteen half-waves which are four times the four half-waves. Alternatively, the conduction pattern and the MASK pattern may include six half-waves, and the control period may include twelve half-waves which are twice the six half-waves.

As described, the positively and negatively symmetric control can be performed without changing the control period when there is a plurality of heaters even if the safety circuit that limits the conduction based on the hardware circuit is activated during normal printing other than during abnormalities such as a failure. Therefore, according to the present embodiment, the control is possible so that the power supplied in the positive half-waves and the power supplied in the negative half-waves are symmetric in the control period even if the safety circuit based on the hardware circuit is activated. Furthermore, the conduction ratio of a plurality of heaters can be maintained.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-127973, filed Jun. 3, 2010, which is hereby incorporated by reference herein in its entirety.

What is claimed is:

1. A fixing apparatus comprising, a heating unit having a heating element that heats a toner image, a control unit that controls power supplied from an AC power supply to the heating element, and a limiting unit that limits the supply of power from the AC power supply to the heating element by a hardware circuit,
wherein, when N is an integer, the control unit controls to make the power supplied in positive half-waves and the power supplied in negative half-waves symmetric in a control period including a plurality of N half-waves of the AC power supply, and
when M is an integer, the control unit controls to supply the power of (N-M+1) half-waves from an M-th half-wave to an N-th half-wave after a limitation of the supply of the power by the limiting unit is released if the limiting unit limits the supply of the power from the AC power supply to the heating element at the M-th half-wave in the control period.

2. The fixing apparatus according to claim 1, further comprising, a temperature detection unit that detects a temperature of the heating element,
wherein the limiting unit limits the supply of the power from the AC power supply to the heating element if the temperature detection unit detects that the temperature of the heating element exceeds a predetermined temperature.

3. The fixing apparatus according to claim 1, further comprising, a pressurizing unit that forms a nip portion by pressure contacting with the heating unit, and a number of rotations detection unit that detects the number of rotations of the pressurizing unit,
Wherein the limiting unit limits the supply of the power from the AC power supply to the heating element if the number of rotations detection unit detects that the number of rotations of the pressurizing unit is smaller than a predetermined number of rotations.

4. The fixing apparatus according to claim 1, wherein the control unit controls the supply of the power based on wave number control in the control period.

5. The fixing apparatus according to claim 1, wherein the control unit controls the supply of the power based on a combination of phase control and the wave number control in the control period.
